(19) United States
(12) Patent Application Publication
(10) Pub. No.: US 2019/0004237 A1
(43) Pub. Date: Jan. 3, 2019

(54) OPTICAL SHEET, SURFACE LIGHT SOURCE DEVICE AND DISPLAY DEVICE

(71) Applicant: Dai Nippon Printing Co., Ltd, Tokyo (JP)

(72) Inventor: Keiko KITANO, Tokyo (JP)

(73) Assignee: Dai Nippon Printing Co., Ltd, Tokyo (JP)

(21) Appl. No.: 15/745,243

(22) PCT Filed: Aug. 12, 2015
(86) PCT No.: PCT/JP2015/072848

§ 371 Date: Jan. 16, 2018

(51) Int. Cl. F21V 8/00; B32B 3/30; B32B 27/20; B32B 27/08; B32B 27/36

(52) U.S. Cl. CPC G02B 6/0051; B32B 3/30; B32B 27/20; B32B 2457/20; B32B 27/36; G02B 6/0053; B32B 27/08

(57) ABSTRACT

An optical sheet 60 includes a substrate layer 65, a mat layer 70 and a prism layer 80. The mat layer includes first light diffusing particles 71, second light diffusing particles 72 and a binder resin 73. The refractive index n₂ of the second light diffusing particles differs from the refractive index n_{b} of the binder resin and the refractive index n₁ of the first light diffusing particles. The average particle diameter d₁ of the first light diffusing particles, the average particle diameter d₂ of the second light diffusing particles, and the thickness t_{b} of the mat layer in those regions where no first light diffusing particles and no second light diffusing particles are present, satisfy the following relation: d₂<t_{b}<d₁.

### TECHNICAL FIELD

The present invention relates to an optical sheet having a mat layer and a prism layer, and more particularly to an optical sheet which can effectively prevent the occurrence of glare. The present invention also relates to a surface light source device and a display device which can effectively prevent the occurrence of glare.

### BACKGROUND ART

Optical sheets having a mat layer including light diffusing particles and a binder resin, and a prism layer including a linear array of unit prisms have been widely used in a variety of industrial fields (see e.g. JP 2000-338310A). Such an optical sheet can be incorporated and used, for example, in a surface light source device which planarly emits light. The surface light source device can be used, for example, as a backlight for illuminating a liquid crystal display panel from the back. In such an optical sheet, the prism layer functions to correct the direction of the optical axis of incident light. The mat layer, on the other hand, functions to diffuse exiting light from the optical sheet, thereby smoothing the angular distribution of luminance and widening the viewing angle and, in addition, hiding defects such as a bright point and a dark point (point defect).

However, it has been confirmed that in a display device in which an optical sheet is disposed such that the mat layer of the optical sheet faces an image display panel (hereinafter also referred to simply as a display panel) having a pixel array, there may occur a problem, so-called “glare”, which is the phenomenon of the appearance of a number of granular visible color components. The present inventors have confirmed that the occurrence of glare is especially pronounced in an optical sheet in which unit prisms are arranged at a fine pitch, in particular an optical sheet in which unit prisms are arranged at a pitch of not more than 35 μm. As a matter of course, the occurrence of glare directly reduces the color reproducibility of a display image, thereby degrading the display quality of the display device.

### DISCLOSURE OF THE INVENTION

The present invention has been made in view of the above situation. It is therefore an object of the present invention to provide an optical sheet, a surface light source device and a display device which can effectively prevent the occurrence of glare.

An optical sheet according to the present invention, having a pair of opposing surfaces, comprises: a sheet-like substrate layer; a mat layer, formed on one side of the substrate layer, including first light diffusing particles, second light diffusing particles and a binder resin; and a prism layer, formed on the other side of the substrate layer, including unit prisms arranged in one direction, each unit prism extending linearly in a direction intersecting the one direction, wherein one of the pair of surfaces is formed as a mat surface of the mat layer, and the other of the pair of surfaces is formed as a prism surface of the prism layer, wherein a refractive index of the second light diffusing particles differs from a refractive index of the binder resin and a refractive index of the first light diffusing particles, and wherein the following relation is satisfied:

d₂<t_{b}<d₁

where d₁ is an average particle diameter of the first light diffusing particles, d₂ is an average particle diameter of the second light diffusing particles, and t_{b} is a thickness of the mat layer in those regions where no first light diffusing particles and no second light diffusing particles are present.

In the optical sheet according to the present invention, the following relation may be satisfied:

d₂ [μm]<t_{b} [μm]<d₁ [μm]<P/2 [μm]

where d₁ is the average particle diameter of the first light diffusing particles, d₂ is the average particle diameter of the second light diffusing particles, t_{b} is the thickness of the mat layer in those regions where no first light diffusing particles and no second light diffusing particles are present, and P is an arrangement pitch of the unit prims in said one direction.

In the optical sheet according to the present invention, each unit prism may have a first surface which faces one side in said one direction, and a second surface which faces the other side in said one direction; and the following relation may be satisfied:

d₂ [μm]<t_{b} [μm]<d₁ [μm]<Wb₂ [μm]

where d₁ is the average particle diameter of the first light diffusing particles, d₂ is the average particle diameter of the second light diffusing particles, t_{b} is the thickness of the mat layer in those regions where no first light diffusing particles and no second light diffusing particles are present, and Wb₂ is a length of the second surface in said one direction.

In the optical sheet according to the present invention, each unit prism may have a first surface which faces one side in said one direction, and a second surface which faces the other side in said one direction; the second surface may include element surfaces disposed such that in a main cross-section of the optical sheet, parallel to both said one direction and a normal direction to the substrate layer, an inclination angle of the second surface with respect to said one direction increases with distance from the top of the unit prism, located farthest from the substrate layer, and takes a maximum value at either base end portion of the unit prism, located closest to the substrate layer; and the following relation may be satisfied:

d₂ [μm]<Wb₂ₚₘᵢₙ [μ]

where d₂ is the average particle diameter of the second light diffusing particles, and Wb₂ₚₘᵢₙ is a minimum value of the lengths of the element surfaces, contained in each unit prism, in said one direction.

In the optical sheet according to the present invention, the following relation may be satisfied:

n₁≤n_{b}<n₂

where n₁ is a refractive index of the first light diffusing particles, n₂ is a refractive index of the second light diffusing particles, and n_{b} is a refractive index of the binder resin.

In the optical sheet according to the present invention, the following relation may be satisfied:

50≤(N₂/N₁)≤200

where N₁ is a number of the first light diffusing particles contained in the mat layer, and N₂ is a number of the second light diffusing particles contained in the mat layer.

The optical sheet according to the present invention may have a haze value of not less than 90%.

The optical sheet according to the present invention may be superimposed on a display panel, with the mat layer being located on the display panel side of the substrate layer.

A surface light source device according to the present invention comprises: a light guide plate; a light source disposed lateral to the light guide plate; and any one of the above-described optical sheets according to the present invention, disposed such that the prism layer faces the light guide plate.

A display device according to the present invention comprises: the above-described surface light source device according to the present invention; and a display panel disposed opposite the surface light source device.

The present invention makes it possible to effectively prevent the occurrence of glare.

### BRIEF DESCRIPTION OF THE DRAWINGS

FIG. 1 is a diagram illustrating an embodiment of the present invention, and is a cross-sectional view showing a schematic construction of a display device and surface light source device;

FIG. 2 is a diagram illustrating the action of the surface light source device of FIG. 1;

FIG. 3 is a perspective view showing, from the side of its light exit surface, a light guide plate incorporated in the surface light source device of FIG. 1;

FIG. 4 is a perspective view showing, from the side of its back surface, the light guide plate incorporated in the surface light source device of FIG. 1;

FIG. 5 is a diagram illustrating the action of the light guide plate, showing the light guide plate in a cross-section along the line V-V of FIG. 3;

FIG. 6 is a perspective view showing an optical sheet incorporated in the surface light source device of FIG. 1;

FIG. 7 is a partial cross-sectional view showing the optical sheet of FIG. 6 in the main cross-section;

FIG. 8 is an enlarged cross-sectional view showing the mat layer of the optical sheet of FIG. 6;

FIG. 9 is a partial cross-sectional view showing the optical sheet of FIG. 6 in the main cross-section;

FIG. 10 is a partial cross-sectional view showing a variation of an optical sheet in the main cross-section;

FIG. 11 is a diagram illustrating an exemplary method for producing an optical sheet;

FIG. 12 is a diagram illustrating the exemplary method for producing an optical sheet;

FIG. 13 is a graph showing the angular distribution of luminance on the light emitting surface of a surface light source device, illustrating the influence of the reflection characteristics of a reflective sheet on the angular distribution of luminance;

FIG. 14 is a diagram corresponding to FIG. 1, illustrating a variation of a surface light source device;

FIG. 15 is a diagram corresponding to FIG. 1, illustrating another variation of a surface light source device;

FIG. 16 is a diagram showing the cross-sectional shape of a unit prism in the main cross-section of an optical sheet; and

FIG. 17 is a diagram showing the cross-sectional shape of a unit prism in the main cross-section of an optical sheet produced as a sample.

### DESCRIPTION OF THE PREFERRED EMBODIMENTS

Preferred embodiments of the present invention will now be described with reference to the drawings. In the drawings attached hereto, scales, horizontal to vertical dimensional ratios, etc. are exaggeratingly modified from those of the real things for the sake of illustration and easier understanding.

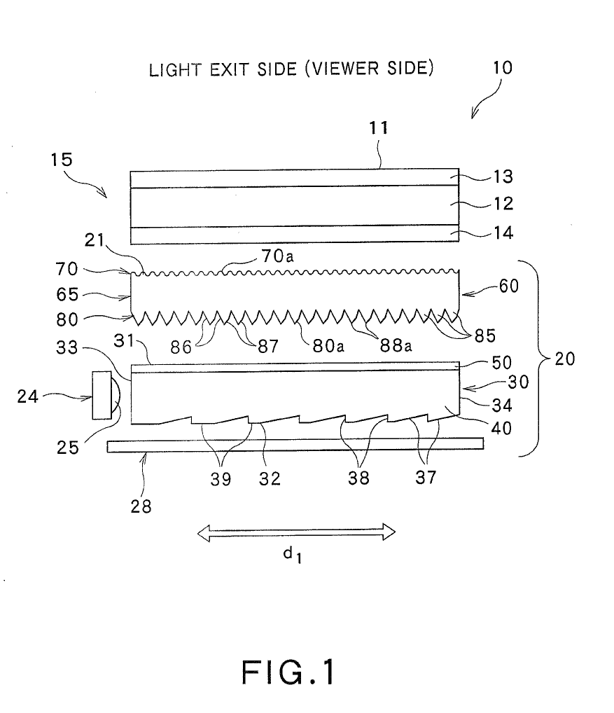

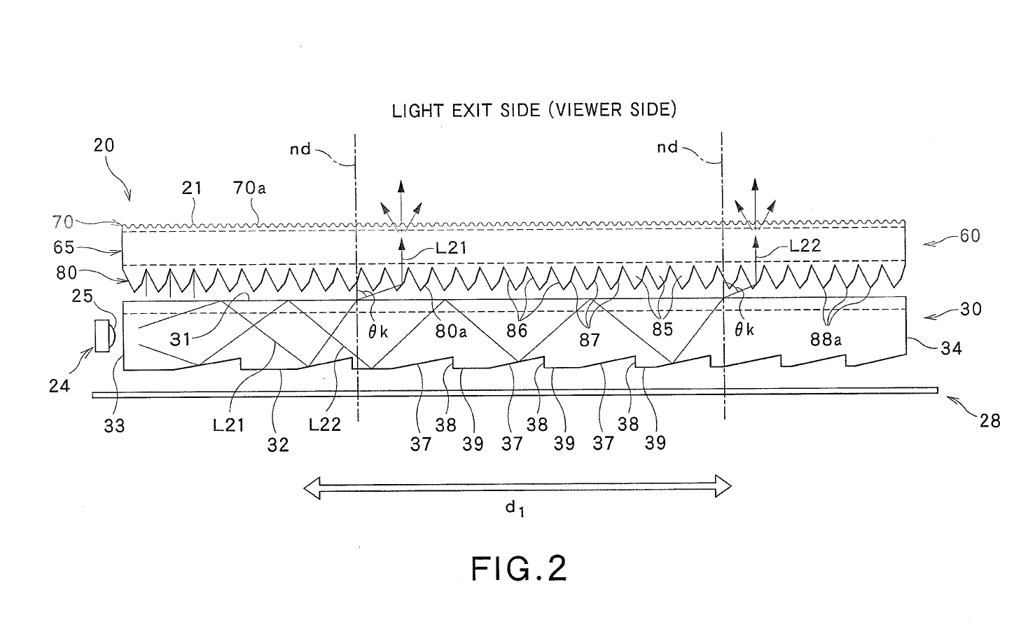

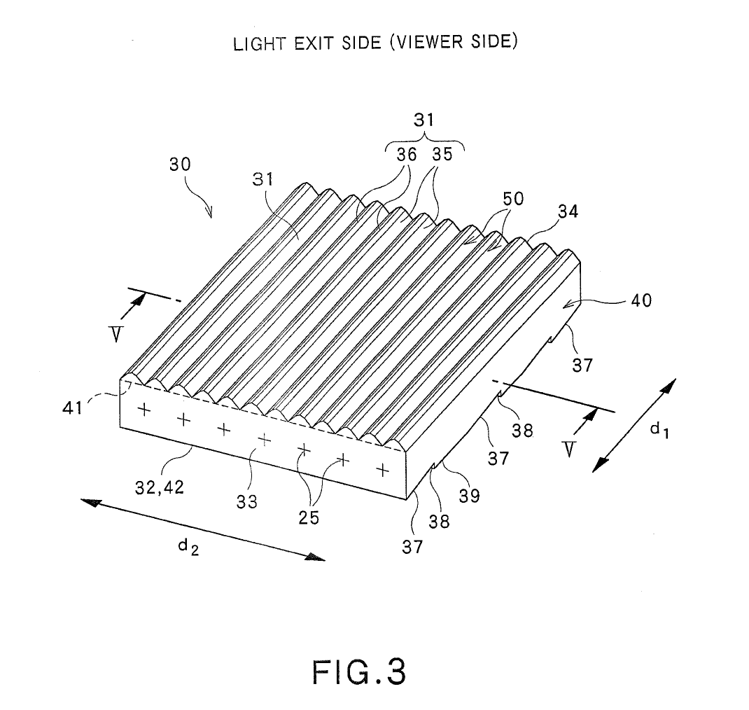

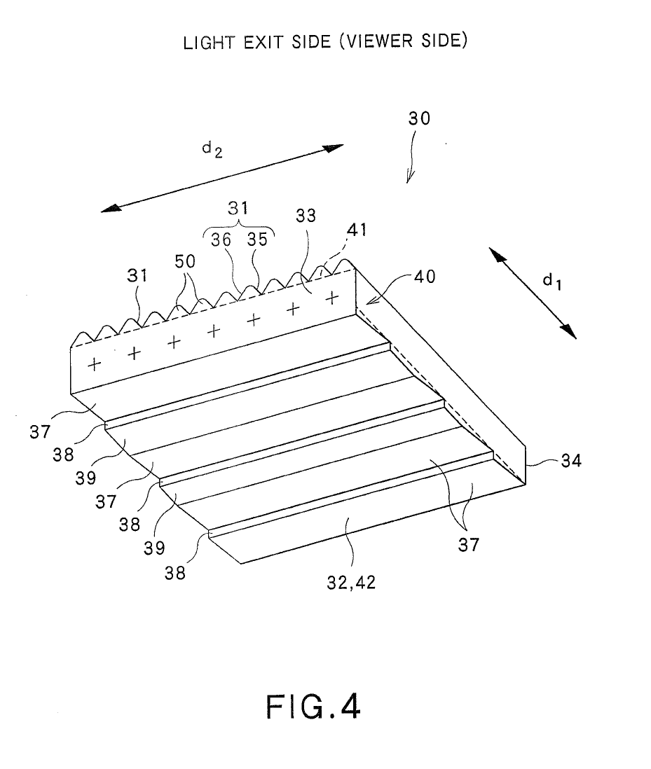

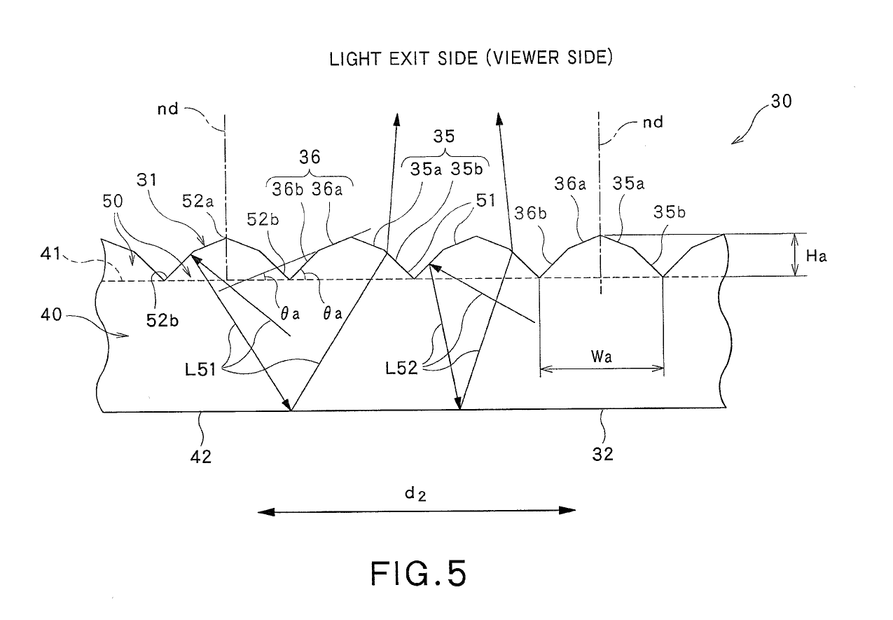

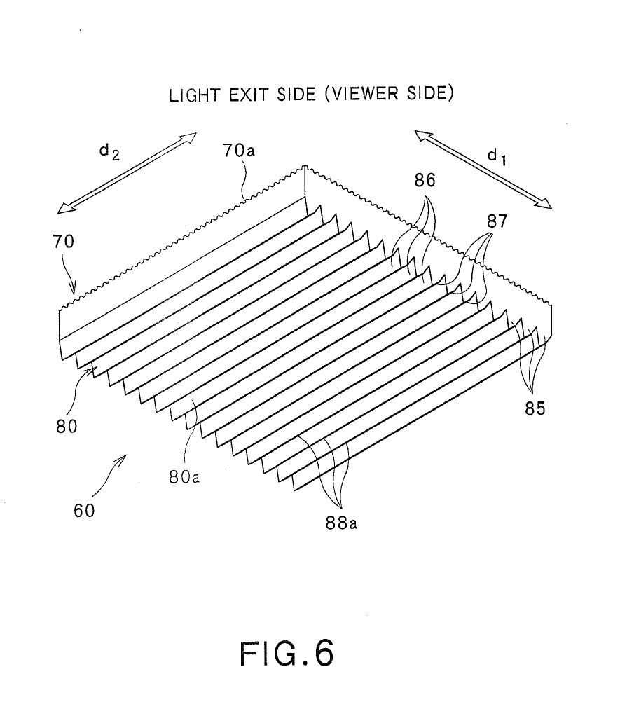

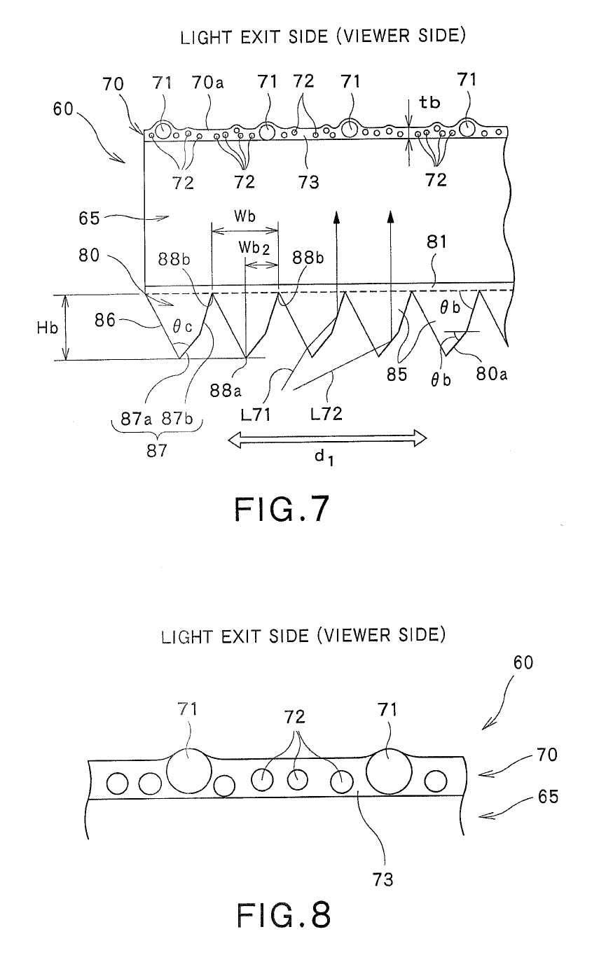

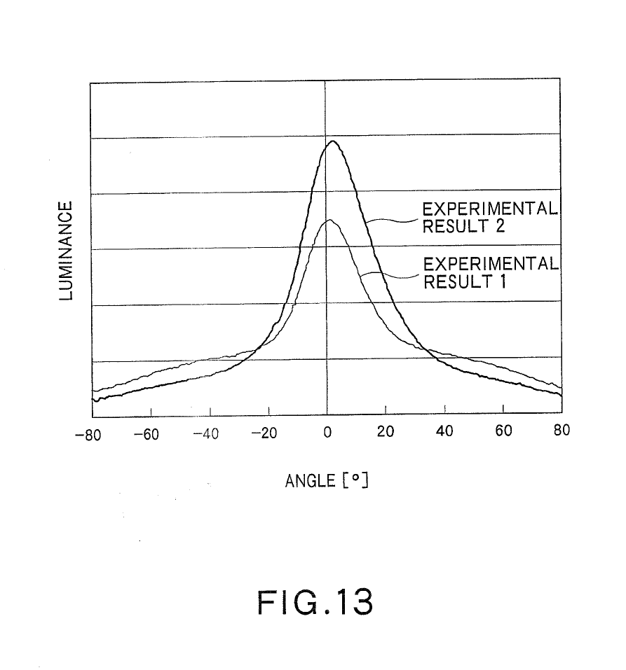

FIGS. 1 through 13 are diagrams illustrating an embodiment of the present invention. Of these, FIG. 1 is a cross-sectional view showing a schematic construction of a liquid crystal display device and surface light source device, and FIG. 2 is a cross-sectional view illustrating the action of the surface light source device. FIGS. 3 and 4 are perspective views showing a light guide plate included in the surface light source device, and FIG. 5 is a cross-sectional view showing the light guide plate in the main cross-section of the light guide plate. FIG. 6 is a perspective view showing an optical sheet included in the surface light source device, and FIG. 7 is a cross-sectional view showing the optical sheet in the main cross-section. FIGS. 12 and 13 are diagrams illustrating an exemplary method for producing an optical sheet. FIG. 13 is a graph showing the angular distribution of luminance, measured on the light emitting surface of the surface light source device of FIG. 1.

As shown in FIG. 1, the display device 10 includes a liquid crystal display panel 15 and a surface light source device 20, disposed behind the liquid crystal display panel 15, for planarly illuminating the liquid crystal display panel 15 from the back. The display device 10 has a display surface 11 for displaying an image on it. The liquid crystal display panel 15 is configured to function as a shutter which controls transmission and blocking of light from the surface light source device 20 for each pixel, and form an image on the display surface 11.

The illustrated liquid crystal display panel 15 includes an upper polarizing plate 13 disposed on the light exit side, a lower polarizing plate 14 disposed on the light entrance side, and a liquid crystal cell 12 disposed between the upper polarizing plate 13 and the lower polarizing plate 14. The polarizing plates 14, 13 function to resolve incident light into two orthogonal polarization components (P wave and S wave), and transmit a linear polarization component (e.g. P wave) vibrating in one direction (direction parallel to the transmission axis) and absorb a linear polarization component (e.g. S wave) vibrating in the other direction perpendicular to the one direction (parallel to the absorption axis).

An electric field can be applied to each pixel area of the liquid crystal layer 12. The orientation direction of liquid crystal molecules in the liquid crystal layer 12 changes depending on application/non-application of an electric field. For example, a polarization component vibrating in a particular direction, which has passed through the lower polarizing plate 14 disposed on the light entrance side, turns its polarization direction by 90 degrees when it passes through the liquid crystal layer 12 to which an electric field is being applied, whereas the polarization component maintains its polarization direction when it passes through the liquid crystal layer 12 to which no electric field is being applied. Thus, transmission through or absorption and blocking by the upper polarizing plate 13, disposed on the light exit side of the lower polarizing plate 14, of the polarization component vibrating in the particular direction, which has passed through the lower polarizing plate 14, can be controlled by application/non-application of an electric field to the liquid crystal layer 12.

In this manner, the liquid crystal display panel (liquid crystal display section) 15 can control transmission or blocking of light from the surface light source device 20 for each pixel. The details of the liquid crystal display panel 15 are known from a number of documents (e.g. “Dictionary of Flat Panel Display”, edited by T. Uchida and H. Uchiike, 2001, Kogyo Chosakai Publishing Co., Ltd.), and hence a further detailed description thereof is omitted.

The surface light source device 20 will now be described. The surface light source device 20 has a light emitting surface 21 which planarly emits light, and in this embodiment is used as a device for illuminating the liquid crystal display panel 15 from the back.

As shown in FIG. 1, the surface light source device 20 is configured as an edge-light type surface light source device, and includes a light guide plate 30, a light source 24 disposed lateral to one side (left side in FIG. 1) of the light guide plate 30, an optical sheet (prism sheet) 60 and a reflective sheet 28, both disposed opposite the light guide plate 30. In the illustrated embodiment, the optical sheet 60 is disposed in a position directly facing the liquid crystal display panel 15. The light exit surface of the optical sheet 60 defines a light emitting surface 21.

In the illustrated embodiment, as with the display surface 11 of the liquid crystal display device 10 and the light emitting surface 21 of the surface light source device 20, the light exit surface 31 of the light guide plate 30 is formed in a square shape in a plan view (as viewed from above in FIG. 1). Thus, the light guide plate 30 is configured as a cuboidal member having a pair of main surfaces (light exit surface 31 and back surface 32) and four side surfaces defined between the pair of main surfaces, and in which the thickness-direction sides are shorter than the other sides. Likewise, the optical sheet 60 and the reflective sheet 28 are each configured as a cuboidal member in which the thickness-direction sides are shorter than the other sides.

The light guide plate 30 has the light exit surface 31 which is the main surface on the side of the liquid crystal display panel 15, the back surface 32 which is the other main surface opposite to the light exit surface 31, and the side surfaces extending between the light exit surface 31 and the back surface 32. One of two side surfaces that oppose each other in a first direction d₁ is a light entrance surface 33. As shown in FIG. 1, the light source 24 is disposed opposite the light entrance surface 33. Light that has entered the light guide plate 30 through the light entrance surface 33 is guided in the light guide plate 30 approximately along the first direction (light guide direction) d₁ toward the opposite surface 34 that opposes the light entrance surface 33. As shown in FIGS. 1 and 2, the optical sheet 60 is disposed opposite the light exit surface 31 of the light guide plate 30, and the reflective sheet 28 is disposed opposite the back surface 32 of the light guide plate 30.

Various types of light emitters, including a linear cold-cathode tube, a fluorescent tube, point-like LEDs (light emitting diodes), an incandescent bulb, etc., can be used as the light source 24. In this embodiment the light source 24 is comprised of a large number of point-like light emitters 25, in particular light emitting diodes (LEDs), arranged side by side along the longitudinal direction (direction perpendicular to the plane of the paper, i.e. the normal direction to the plane, in FIG. 1) of the light entrance surface 33. The arrangement positions of the point-like light emitters 25 constituting the light source 24 are shown in the light guide plate 30 shown in FIGS. 3 and 4.

The reflective sheet 28 is a member to reflect light that has leaked from the back surface 32 of the light guide plate 30 so that the light will re-enter the light guide plate 30. The reflective sheet 28 may be comprised of a white scattering reflection sheet, a sheet composed of a material having high reflectance, such as a metal, a sheet having a surface film layer of a high-reflectance material (e.g. a metal film), or the like. The reflection of light from the reflective sheet 28 may be regular reflection (mirror reflection) or diffuse reflection. In the case where the reflection of light from the reflective sheet 28 is diffuse reflection, the diffuse reflection may be isotropic diffuse reflection or anisotropic diffuse reflection.

The term “light exit side” herein refers to downstream side (viewer side, e.g. upper side in FIG. 1) in the traveling direction of light that travels between the components of the display device 10, namely the light source 24, the light guide plate 30, the optical sheet 60 and the liquid crystal display panel 15, without turning back, and exits the display device 10 and travels toward a viewer. The term “light entrance side” herein refers to upstream side in the traveling direction of light that travels between the components of the display device 10, namely the light source 24, the light guide plate 30, the optical sheet 60 and the liquid crystal display panel 15, without turning back, and exits the display device 10 and travels toward a viewer.

The terms “sheet”, “film”, “plate”, etc. are not used herein to strictly distinguish them from one another. Thus, the term “sheet” includes a member which can also be called a film or plate.

The term “sheet plane (plate plane, film plane)” herein refers to a plane which coincides with the planar direction of an objective sheet-like member when taking a wide and global view of the sheet-like member. In this embodiment the plate plane of the light guide plate 30, the sheet plane (plate plane) of the below-described base portion 40 of the light guide plate 30, the sheet plane of the optical sheet 60, the sheet plane of the reflective sheet 28, the panel plane of the liquid crystal display panel, the display surface 11 of the display device 10, and the light emitting surface 21 of the surface light source device 20 are parallel to each other. The term “front direction” herein refers to the normal direction to the light emitting surface 21 of the surface light source device 20, and in this embodiment coincides with the normal direction to the plate plane of the light guide plate 30, the normal direction to the sheet plane of the optical sheet 60, the normal direction to the display surface 11 of the display device 10, etc. (see e.g. FIG. 2).

The light guide plate 30 will now be described in greater detail mainly with reference to FIGS. 2 through 5. As well shown in FIGS. 2 through 5, the light guide plate 30 includes a base portion 40 formed in a plate-like shape, and a number of unit optical elements 50 formed on a one-side surface (viewer-facing surface, light exit-side surface) 41 of the base portion 40. The base portion 40 is configured as a flat plate-like member having a pair of parallel main surfaces. The other-side surface 42 of the base portion 40, which faces the reflective sheet 28, constitutes the back surface 32 of the light guide plate 30.

The terms “unit prism”, “unit shaped element”, “unit optical element” and “unit lens” herein refer to an element which functions to exert an optical action, such as refraction or reflection, on light and to thereby change the traveling direction of the light, and are not used herein to strictly distinguish them from one another.

As well shown in FIG. 4, the other-side surface 42 of the base portion 40, constituting the back surface 32 of the light guide plate 30, is configured as an uneven surface. In a specific construction, the back surface 32 has inclined surfaces 37, stepped surfaces 38 extending in the normal direction nd of the light guide plate 30, and connecting surfaces 39 extending in the plate-plane direction of the light guide plate 30, which define the irregularities of the other-side surface 42 of the base portion 40. Light is guided in the light guide plate 30 through total reflection at the pair of main surfaces 31, 32 of the light guide plate 30. On the other hand, each inclined surface 37 is inclined with respect to the plate plane of the light guide plate 30 such that the distance to the light exit surface 31 decreases with the increasing distance from the light entrance surface 33. Accordingly, the incident angle of light entering the main surface 31, 32 becomes smaller after the light reflects at an inclined surface 37. When the incident angle of light to the main surface 31, 32 becomes less than the critical angle for total reflection by reflection of the light at an inclined surface(s) 37, the light will exit the light guide plate 30. Thus, each inclined surface 37 functions as an element to extract light from the light guide plate 30.

The distribution of the amount of light exiting the light guide plate 30 along the first direction d₁ which is the light guide direction can be controlled by adjusting the distribution of the inclined surfaces 37 along the first direction d₁ in the back surface 32. In the embodiment illustrated in FIGS. 2 through 5, the proportion of the area of an inclined surface 37 in the back surface 32 increases as the distance of the inclined surface 37 from the light entrance surface 33 in the light guide direction increases. According to the thus-constructed light guide plate 30, exit of light from the light guide plate 30 is promoted in a region remote from the light entrance surface 33 along the light guide direction. This can effectively prevent decrease in the amount of exiting light with the increasing distance from the light entrance surface 33.

Unit optical elements 50 provided on the one-side surface 41 of the base portion 40 will now be described. As well shown in FIGS. 3 and 4, the unit optical elements 50 are arranged side by side on the one-side surface 41 of the base portion 40 in an arrangement direction (lateral direction in FIG. 5) intersecting the first direction d₁ and parallel to the one-side surface 41 of the base portion 40. Each unit optical element 50 extends linearly on the one-side surface 41 of the base portion 40 in a direction (d₁ direction) intersecting the arrangement direction.

Particularly in this embodiment, as shown in FIG. 3, the unit optical elements 50 are arranged on the one-side surface 41 of the base portion 40 side by side with no space therebetween in a second direction (arrangement direction) d₂ perpendicular to the first direction d₁. Thus, the light exit surface 31 of the light guide plate 30 consists of the inclined surfaces 35, 36 of the unit optical elements 50. Each unit optical element 50 extends in a straight line along the first direction d₁ perpendicular to the arrangement direction. Each unit optical element 50 has a columnar shape, and has the same cross-sectional shape along the longitudinal direction. Further, in this embodiment all the unit optical elements 50 have the same construction. Accordingly, the light guide plate 30 of this embodiment has a constant cross-sectional shape at various positions along the first direction d₁.

A description will now be given of the cross-sectional shape of the unit optical elements 50 in the cross-section shown in FIG. 5, i.e. the cross-section parallel to both the arrangement direction (second direction) of the unit optical elements 50 and the normal direction nd to the one-side surface 41 of the base portion 40 (plate plane of the light guide plate 30) (hereinafter also referred to simply as the “main cross-section”). As shown in FIG. 5, in the illustrated embodiment, each unit optical element 50 has a tapered cross-sectional shape, tapered toward the light exit side, in the main cross-section of the light guide plate 30. Thus, in the main cross-section of the light guide plate 30, the width of each unit optical element 50, along a direction parallel to the plate plane of the light guide plate 30, decreases with distance from the base portion 40 in the normal direction nd of the light guide plate 30.

Further, in this embodiment, in the contour 51 (corresponding to the light exit surface 31) of each unit optical element 50 in the main-cross section, a light exit surface angle θa, which is the angle of the contour with respect to the one-side surface 41 of the base portion 40, changes such that it increases with distance from the top 52a of the contour 51 of the unit optical element 50, i.e. the farthest point from the base portion 40, and takes a maximum value at either base end portion 52b located closest to the base portion 40. The light exit surface angle θa can be set, for example, in the manner disclosed in Japanese Patent Laid-Open Publication No. 2013-51149.

As described above, the light exit surface angle θa refers to the angle of the light exit-side surface (contour) 51 of a unit optical element 50 with respect to the one-side surface 41 of the base portion 40 in the main cross-section of the light guide plate 30. When the contour (light exit-side surface) 51 of each unit optical element 50 in the main cross-section has the shape of a polygonal line as in the embodiment illustrate in FIG. 5, the light exit surface angle θa refers to the angle formed between a straight line segment of the polygonal line and the one-side surface 41 of the base portion 40 (more precisely the smaller one (minor angle) of the two angles formed). On the other hand, when the contour (light exit-side surface) 51 of each unit optical element 50 in the main cross-section has the shape of a curved line, the light exit surface angle θa refers to the angle formed between a tangent to the curved contour 51 of a unit optical element 50 and the one-side surface 41 of the base portion 40 (more precisely the smaller one (minor angle) of the two angles formed).

The exemplary unit optical elements 50 shown in FIG. 5 each have, in the main cross-section of the light guide plate 30, a pentagonal shape whose one side lies on the one-side surface 41 of the base portion 40 and whose two sides lie between the top 52a and each base end portion 52b of the contour 51, or a shape in which one or more of the corners of the polygonal shape are chamfered. In the illustrated embodiment, in order to effectively increase the front-direction luminance and to impart symmetry to the angular distribution of luminance in a plane along the second direction d₂, the cross-sectional shape of each unit optical element 50 in the main cross-section is made symmetrical with respect to the front direction nd. In particular, as well shown in FIG. 5, the light exit-side surface 51 of each unit optical element 50 is composed of a pair of bent surfaces 35, 36 which are symmetrical with respect to the front direction nd. The pair of bent surfaces 35, 36 are connected to each other, and the connection defines the top 52a. The pair of bent surfaces 35, 36 consist of a pair of first surfaces 35a, 36a that define the top 52a, and a pair of second surfaces 35b, 36b extending from the base portion 40 and connecting to the first surfaces 35a, 36a, respectively. The pair of first surfaces 35a, 36a are symmetrical with respect to the front direction nd, and the pair of second inclined surfaces 35b, 36b are also symmetrical with respect to the front direction nd.

In the main cross-section of the light guide plate 30, the ratio (Ha/Wa) of the height Ha of each unit optical element 50 from the base portion 40 in the front direction to the width Wa of the unit optical element 50 in the arrangement direction is preferably not less than 0.3 and not more than 0.45. Such unit optical elements 50, through refraction and reflection at the light exit-side surface 51, can exert excellent light condensing effect on a light component traveling along the arrangement direction (second direction) in which the unit optical elements 50 are arranged and, in addition, can effectively prevent side lobe.

The term “pentagonal shape” herein includes not only a pentagonal shape in the strict sense but also a generally pentagonal shape that may reflect limitations in production technique, a molding error, etc. Similarly, the terms used herein to specify shapes or geometric conditions, such as “parallel”, “perpendicular”, “symmetrical”, etc., should not be bound to their strict sense, and should be construed to include equivalents or resemblances from which the same optical function or effect can be expected.

The dimensions of the light guide plate 30 may be set as follows. The width Wa (see FIG. 5) of each unit optical element 50 may be not less than 10 μm and not more than 500 μm. The thickness of the base portion 40 may be in the range of 0.3 mm to 6 mm.

The thus-constructed light guide plate 30 can be produced e.g. by shaping the unit optical elements 50 on a substrate or by extrusion. While a variety of materials can be used for the base portion 40 of the light guide plate 30 and for the unit optical elements 50, it is preferred to use those materials which are widely used for optical sheets to be incorporated into display devices, have excellent mechanical properties, optical properties, stability and processability, and are commercially available at low costs. Examples of such materials include a transparent resin mainly comprising at least one of an acrylic resin, polystyrene, polycarbonate, polyethylene terephthalate, polyacrylonitrile, etc., and a reactive resin (e.g. ionizing radiation curable resin) such as an epoxy acrylate resin or a urethane acrylate resin. The light guide plate 30 may optionally contain a diffusing component which functions to diffuse light in the light guide plate 30. Particles of a transparent material such as silica (silicon dioxide), alumina (aluminum oxide), an acrylic resin, a polycarbonate resin or a silicone resin, having an average particle size of. about 0.5 to 100 μm, may be used as the diffusing component.

When the light guide plate 30 is produced by curing an ionizing radiation curable resin on a substrate, it is possible to form, together with the unit optical elements 50, a sheet-like land portion between the substrate and the unit optical elements 50. In this case, the base portion 40 consists of the substrate and the land portion formed from the ionizing radiation curable resin. A plate-like resin extrudate containing light diffusing particles can be used as the substrate. When extrusion is employed to produce the light guide plate 30, the base portion 40 and the unit optical elements 50 on the one-side surface 41 of the base portion 40 can be formed integrally.

The optical sheet (prism sheet) 60 will now be described in greater detail mainly with reference to FIG. 2 and FIGS. 6 through 10. The optical sheet 60 is a member which functions to change the traveling direction of transmitted light, and corrects the direction of the optical axis of incident light from the light guide plate 30.

The optical sheet 60 shown in FIGS. 6 and 7 comprises a sheet-like substrate layer 65, a mat layer 70 formed on one side of the substrate layer 65, and a prism layer 80 formed on the other side of the substrate layer 65. The substrate layer 65 is formed of a resin film such as a polyethylene terephthalate film, and functions as a layer for supporting the mat layer 70 and the prism layer 80. The prism layer 80 includes a number of unit prisms 85 arranged in one direction. Each unit prism 85 extends linearly in a direction intersecting the one direction. The optical sheet 60 has a pair of main surfaces. One main surface of the optical sheet 60 is formed as a mat surface 70a of the mat layer 70. The other main surface of the optical sheet 60 is formed as a prism surface 80a of the prism layer 80. As shown in FIGS. 1 and 2, the optical sheet 60 is disposed such that the mat surface 70a faces the liquid crystal display panel 15, and the prism surface 80a faces the light guide plate 30. The arrangement direction of the unit prisms 85 is parallel to the first direction d₁, which is the direction in which light is guided by the light guide plate 30 as described above.

The mat layer 70 comprises first light diffusing particles 71, second light diffusing particles 72 and a binder resin 73. The first light diffusing particles 71 and the second light diffusing particles 72 can act on light traveling in the mat layer 70 to change the traveling direction of the light by reflection, refraction, etc. The first light diffusing particles 71 and the second light diffusing particles 72 are made of different materials. The refractive index n₁ of the first light diffusing particles 71 differs from the refractive index n₂ of the second light diffusing particles 72. Further, the first light diffusing particles 71 and the second light diffusing particles 72 have different particle sizes. As shown in FIG. 7, the following relation is satisfied:

d₂<t_{b}<d₁ (a)

where d₁ is the average particle diameter of the first light diffusing particles 71, d₂ is the average particle diameter of the second light diffusing particles 72, and t_{b} is the thickness of the mat layer 70 in those regions where no first light diffusing particles 71 and no second light diffusing particles 72 are present.

For example, the average particle diameter d₁ of the first light diffusing particles 71 may be not less than 3.5 μm and not more than 8.0 μm, the average particle diameter d₂ of the second light diffusing particles 72 may be not less than 0.8 μm and not more than 5.0 μm, and the thickness t_{b} of the mat layer 70 in those regions where no first light diffusing particles 71 and no second light diffusing particles 72 are present may be not less than 0.8 μm and not more than 7.5 μm.

As well shown in FIG. 7, since the average particle diameters d₁, d₂ of the light diffusing particles 71, 72 and the thickness t_{b} of the mat layer 70 satisfy the above relation (a), the mat surface 70a of the mat layer 70 is an uneven surface with raised portions formed in those regions where the first light diffusing particles 71, having the average particle diameter d₁ larger than the thickness t_{b} of the binder resin 73, are present. The uneven mat surface 70a exerts the effect of changing the traveling direction of light at the interface between the surface 70a and the adjacent air layer. Thus, the first light diffusing particles 71 can exert a light diffusing effect mainly by providing irregularities to the mat surface 70a.

On the other hand, as well shown in FIG. 7, the second light diffusing particles 72, having the average particle diameter d₂ smaller than the thickness t_{b} of the mat layer 70, are buried in the binder resin 73. Therefore, while the second light diffusing particles 72 may form slight irregularities due to a difference in the shrinkage ratio between the particles 72 and the binder resin 73, the second light diffusing particles 72 generally do not form such irregularities as to be capable of exerting a strong light diffusing effect. However, the refractive index n₂ of the second light diffusing particles 72 differs from the refractive index n_{b} of the binder resin 73, i.e. n₂>n_{b} or n₂<n_{b}. Therefore, each second light diffusing particle 72 forms an interface, which has a refractive index difference, between it and the binder resin 73. This enables the second light diffusing particles 72 to exert a light diffusing effect.

As described below, the first light diffusing particles 71 are provided to obscure defects in appearance, such as an interference pattern, a wetting pattern (also called “wet-out”) looking like staining with a liquid, etc., produced when the optical sheet 60 is superimposed on another member. From the viewpoint of effectively obscuring glare, it is preferred that the first light diffusing particles 71 not exert a strong light diffusing effect. It is therefore preferred that the interfaces between the second light diffusing particles 72 and the binder resin 73 in the mat layer 70 mainly contribute to the light diffusing effect of the mat layer 70. From the viewpoints of the second light diffusing particles 72 obscuring glare and exerting the below-described hiding effect, and the first light diffusing particles 71 obscuring defects in appearance while preventing the occurrence of glare, it is preferred that the volume ratio between the first light diffusing particles 71 and the second light diffusing particles 72 be in the range of 1:1 to 1:10, more preferably in the range of 1:3 to 1:10. Further, from the viewpoints of the second light diffusing particles 72 obscuring glare and exerting the below-described hiding effect, and the first light diffusing particles 71 obscuring defects in appearance while preventing the occurrence of glare, it is preferred that the following relation be satisfied:

50≤(N₂/N₁)≤200

where N₁ is the number of the first light diffusing particles 71 (number of primary particles) and N₂ is the number of the second light diffusing particles 72 (number of primary particles).

Because of the design concept of the present invention that the first light diffusing particles 71 are not allowed to exert a strong light diffusing effect, the refractive index n₁ of the first light diffusing particles 71 may be either equal to or different from the refractive index n_{b} of the binder resin 73, i.e. n₁≥n_{b} or n₁≤n_{b}. The refractive index n₁ of the first light diffusing particles 71 preferably differs from the refractive index n₂ of the second light diffusing particles 72, i.e. n₁>n₂ or n₁<n₂.

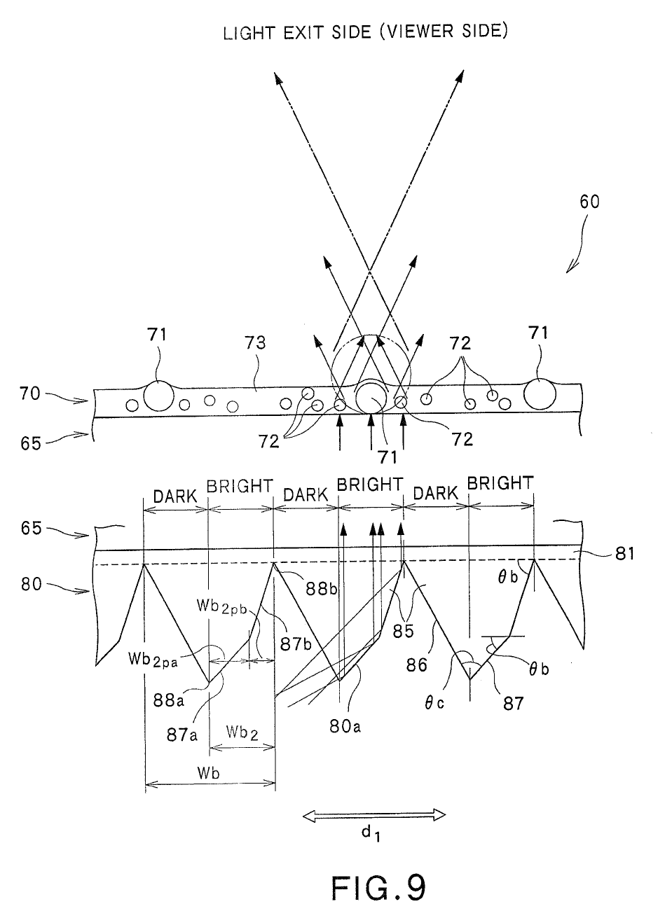

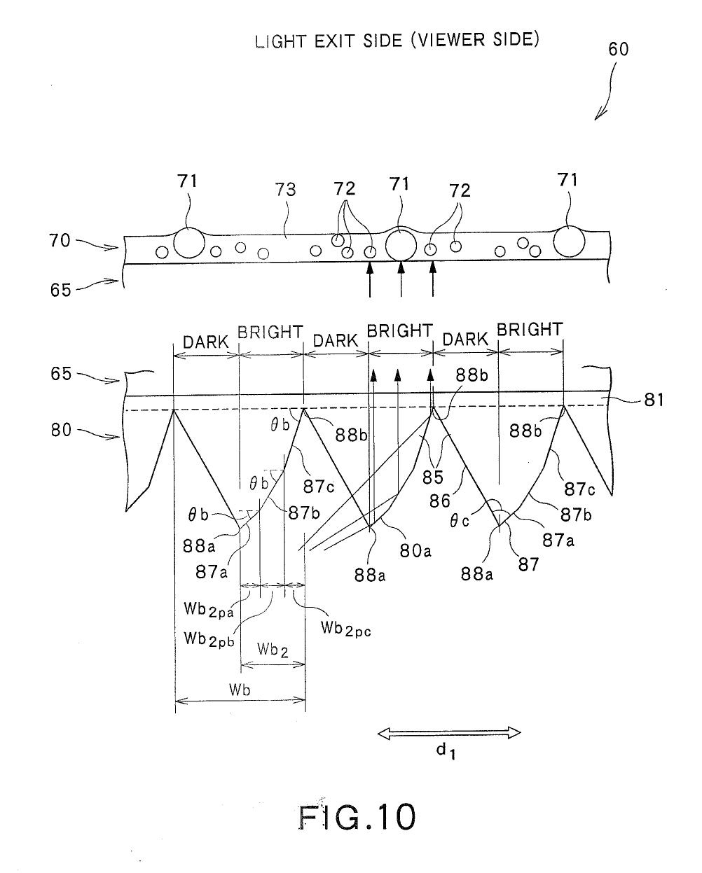

As shown in FIG. 8, the mat surface 70a of the mat layer 70 is an uneven surface where raised portions are formed due to the presence of the first light diffusing particles 71. The light diffusing effect of the raised portions of the uneven surface can be a lens effect that could cause glare, as will be described below with reference to FIGS. 9 and 10. Therefore, in order to reduce the light diffusing effect of the raised portions of the mat surface 70a, the refractive index n_{b} of the binder resin 73 is preferably made close to 1 so as to make small the difference from the refractive index of the adjacent air layer. As shown in FIG. 8, in some raised portions of the mat surface 70a, first light diffusing particles 71 can be exposed on the binder resin 73. Therefore, as with the refractive index n_{b} of the binder resin 73, the refractive index n₁ of the first light diffusing particles 71 is preferably made close to 1 so as to make small the difference from the refractive index of the adjacent air layer.

In light of the above, and also of the effect of reducing visibility of defects in appearance and the availability of material, it is preferred that the following relation be satisfied:

n₁≤n_{b}<n₂.

Taking into consideration the range of materials which are generally readily available, it is preferred to select those materials whose refractive indices n₁, n₂, n_{b} are: n₁=1.43-1.60, n₂=1.38-2.20, n_{b}=1.43-1.60, the indices n₁, n₂, n_{b} satisfying the above relation. For example, the indices can be selected as follows: n₁=1.49, n₂=1.59, n_{b}=1.51, the numerical values rounded to two decimal places.

The particle diameter of the light diffusing particles 71, 72 refers to the primary particle diameter of the light diffusing particles 71, 72, and means the diameter of the light diffusing particles 71, 72 as they are assumed to be spherical particles. The average particle diameter of the light diffusing particles 71, 72 can be measured by a laser-diffraction particle size distribution measuring method using a precision particle size distribution measuring device “Coulter Multisizer”. The average particle diameter of the light diffusing particles 71, 72, dispersed in the mat layer 70, can be measured from a cross-sectional electron microscope image using, for example, image processing software.

A variety of known particles can be used as the first light diffusing particles 71 and the second light diffusing particles 72 of the mat layer 70. Examples of usable particles include particles of an organic polymer, such as an acrylic resin, a silicon resin, a fluorocarbon polymer, polyester, polycarbonate, or polystyrene; particles of a metal compound or an inorganic material, such as alumina, silica, calcium carbonate, fluorite, cryolite, magnesium fluoride, tin oxide, indium oxide, zirconia, titania, or tungsten oxide; and porous particles containing a gas. The first light diffusing particles 71 and the second light diffusing particles 72 need not necessarily have a spherical shape as shown in FIG. 7, and may have various other shapes including a spheroidal shape and a polyhedral shape such as a cube, a cuboid, a rhombohedron, a regular octahedron, a hexagonal prism, or a dodecahedron. A variety of known resin materials can be used as the binder resin 73. Examples of usable resins include an acrylic resin, a polyester resin, a polyurethane resin, an epoxy resin, etc. Such resins may be of the thermosetting or ionizing radiation curing type (a resin of such a curing type is called a thermosetting resin or an ionizing radiation curable resin). A thermoplastic resin of the solvent drying/curing type or the melting/cooling solidification curing type can also be used.

The prism layer 80 of the optical sheet 60 will now be described. As shown in FIGS. 6 and 7, the prism layer 80 includes a sheet-like land portion 81 formed on the substrate layer 65, and a large number of unit prims 85 arranged on the land portion 81. The land portion 81 is formed due to the below-described production method, and formed integrally with the unit prisms 85 using the same material. The thickness of the land portion 81 is generally about 1 to 10 μm. The provision of the land portion 81 is not essential; it is possible not to provide the land portion 81 (the thickness of the land portion 81 is 0). However, from the viewpoints of enhancing adhesion between the prism layer 80 and the substrate layer 65 and reducing distortion of the prism layer 80 upon its curing/shrinkage, it is preferred to form the land portion 81 having a thickness of about 2 to 8 μm.

The prism surface 80a, which is the other-side surface of the optical sheet 60, is formed by the surfaces of the unit prisms 85, i.e. the prism surfaces. As shown in FIG. 6, the unit prisms 85 are arranged in an arrangement direction parallel to the sheet plane of the optical sheet 60. In the illustrated embodiment, the arrangement direction of the unit prisms 85 is parallel to the above-described first direction d₁. Each unit prism 85 extends linearly in a direction intersecting the arrangement direction. Particularly in the illustrated embodiment, each unit prism 85 extends in a straight line in a direction intersecting the arrangement direction. In the illustrated embodiment, each unit prism 85 extends in a straight line along the second direction d₂ perpendicular to the first direction d₁. Each unit prism 85 has a columnar shape, and has the same cross-sectional shape along the longitudinal direction. The unit prisms 85 have the same construction, and are arranged on the land portion 81 side by side with no space therebetween. Thus, in the illustrated optical sheet 60, the prism surface 80a consists solely of the surfaces 86, 87 of the unit prisms 85.

As well shown in FIG. 7, each unit prism 85 has a first surface 86 and a second surface 87, which are disposed opposite each other in a direction parallel to the sheet plane of the optical sheet 60 and along the arrangement direction, i.e. the first direction d₁. The first surface 86 of each unit prism 85 is located on one side (left side in FIGS. 1 and 2) in the first direction d₁, while the second surface 87 is located on the other side (right side in FIGS. 1 and 2) in the first direction d₁. In particular, the first surface 86 of each unit prism 85 is located on the side nearer to the light source 24 in the first direction d₁, while the second surface 87 of the unit prism 85 is located on the side farther from the light source 24. The first surface 86 functions as a light entrance surface for light that has been emitted from the light source 24, disposed on one side in the first direction d₁, and traveled into the light guide plate 30, and then exited the light guide plate 30 and enters the optical sheet 60. On the other hand, the second surface 87 functions to reflect light that has entered the optical sheet 60, thereby correcting the path of the light.

As well shown in FIG. 7, the first surface 86 and the second surface 87 extend from the land portion 81 and are connected to each other. Base end portions 88b of each unit prism 85 are defined at positions where the first surface 86 and the second surface 87 connect to the land portion 81. A top (or ridge which forms a ridge line) 88a of each unit prism 85, located farthest from the substrate layer 65, is defined at a position where the first surface 86 and the second surface 87 connect to each other.

A description will now be given of the cross-sectional shape of the unit prisms 85 in the cross-section shown in FIG. 7, i.e. the cross-section parallel to both the normal direction nd of the optical sheet 60 (substrate layer 65) and the arrangement direction (first direction d₁) of the unit prisms 85 (hereinafter also referred to simply as the “main cross-section of the optical sheet”). As shown in FIGS. 6 and 7, in the illustrated embodiment, each unit prism 85 has a tapered cross-sectional shape, tapered toward the light entrance side (toward the light guide plate), in the main cross-section of the optical sheet. Thus, in the main cross-section, the width of each unit prism 85, along a direction parallel to the sheet plane of the optical sheet 60, decreases with distance from the substrate layer 65 in the normal direction nd of the optical sheet 60.

In the illustrated embodiment, a reflective surface angle θb, which is the angle of a second surface 87, constituting part of the contour (constituting part of the prism surface 80a) of each unit prism 85 in the main cross-section of the optical sheet, with respect to the sheet plane of the optical sheet 60, is not constant in the second surface 87. As shown in FIG. 7, in the second surface 87, the reflective surface angle θb changes such that it increases with distance from the top 88a of the unit prism 85, located farthest from the substrate layer 65, and takes a maximum value at either base end portion 88b of the unit prism 85, located closest to the substrate layer 65. As shown in FIG. 7, such a unit prism 85 can ensure an excellent light condensing effect both in a base end portion 88b-side area of each second surface. 87 which relatively high-angle light L71, traveling in a direction inclined at a relatively low angle with respect to the front direction nd, mainly enters, and in a top 88a-side area of the second surface 87 which relatively low-angle light L72, traveling in a direction inclined at a relatively high angle with respect to the front direction nd, mainly enters.

In a specific construction, in the illustrated embodiment, the contour of the second surface 87 of each unit prism 85 in the main cross-section of the optical sheet has a shape composed of connected line segments or of connected line segments whose connection(s) is chamfered. In other words, the contour of the second surface 87 of each unit prism 85 has a polygonal line shape, or a shape composed of a polygonal line whose corner(s) is chamfered. More specifically, the second surface 87 includes a first portion (first element surface) 87a that defines the top 88a, and a second portion (second element surface) 87b located adjacent to the first portion 87a and nearer to the substrate layer 65. The reflective surface angle θb of the second portion 87b is larger than the reflective surface angle θb of the first portion 87a.

In another embodiment shown in FIG. 10, the second surface 87 of each unit prism 85 includes a first portion (first element surface) 87a that defines the top 88a, a second portion (second element surface) 87b located adjacent to the first portion 87a and nearer to the substrate layer 65, and a third portion (third element surface) 87c located adjacent to the second portion 87b and nearer to the substrate layer 65. The reflective surface angle θb of the third portion 87c is larger than the reflective surface angle θb of the second portion 87b, and the reflective surface angle θb of the second portion 87b is larger than the reflective surface angle θb of the first portion 87a.

The second surface 87 is not limited to those illustrated in FIGS. 9 and 10, and may include four or more element surfaces.

As described above, the reflective surface angle θb refers to the angle of the second surface 87 of a unit prism 85 with respect to the sheet plane of the optical sheet 60 (the sheet plane of the substrate layer 65) in the main cross-section of the optical sheet. When the contour of the second surface 87 of each unit prism 85 in the main cross-section has the shape of a polygonal line as in the embodiment illustrate in FIG. 7, the reflective surface angle θb refers to the angle formed between a straight line segment of the polygonal line and the sheet plane of the optical sheet 60 (more precisely the smaller one (minor angle) of the two angles formed). On the other hand, when the contour of the second surface 87 of each unit prism 85 in the main cross-section has the shape of a curved line, the reflective surface angle θb refers to the angle formed between a tangent to the curved contour of the second surface 87 and the sheet plane of the optical sheet 60 (more precisely the smaller one (minor angle) of the two angles formed).

In the thus-constructed optical sheet 60, the ratio (Hb/Wb) of the height Hb of each unit prism 85 in the normal direction nd of the optical sheet in the main cross-section of the optical sheet to the width Wb (FIG. 7) of the bottom of the unit prism 85 in the arrangement direction d₁ of the unit prisms 85 in the main cross-section of the optical sheet, affects the light condensing properties and light diffusing properties of the optical sheet 60. The ratio (Hb/Wb) of the height Hb of each unit prism 85 to the width Wb of the bottom of the unit prism 85 is preferably not less than 0.55 and not more than 0.90, more preferably not less than 0.75 and not more than 0.85. The reflective surface angle θb of the first portion 87a of each second surface 87 may be not less than 45° and not more than 60°, and the reflective surface angle θb of the second portion 87b of each second surface 87 may be not less than 50° and not more than 70°. The apex angle θc (see FIG. 7) of each unit prism 85 in the main cross-section of the optical sheet 60 is an acute angle which may typically be not less than 60° and not more than 80°.

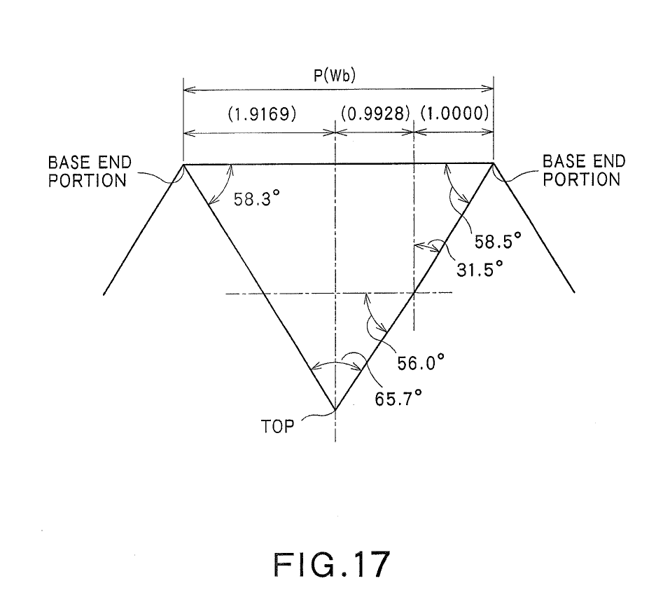

In the case where the unit prisms 85 are arranged side by side with no space therebetween as shown in FIG. 7, the width Wb of the bottom of each unit prism 85 is equal to the arrangement pitch P of the unit prisms 85 (see FIG. 17).

Other dimensions of the optical sheet 60 may be set as follows. In a specific example of the unit prisms 85 having the above construction, the arrangement pitch P of the unit prisms 85 (equal to the width Wb of each unit prism 85 in the illustrated embodiment) may be not less than 10 μm and not more than 200 μm. The height Hb of the unit prisms 85 from the land portion 81 in the normal direction nd to the sheet plane of the optical sheet 60 may be not less than 5.5 μm and not more than 180 μm. In view of the fact that the array of unit prisms 85 is rapidly becoming finer these days, the arrangement pitch P of the unit prisms 85 may preferably be not less than 10 μm and not more than 35 μm.

From the viewpoint of effectively obscuring glare, etc., the average particle diameter d₁ of the first light diffusing particles 71 and the average particle diameter d₂ of the second light diffusing particles 72 are controlled in a range appropriate for the arrangement pitch P of the unit prims 85. In particular, the following relation (s1) is preferably satisfied, and more preferably the following relation (s2) or (s3) is satisfied. Wb₂ in the relation (s3) is the length of each second surface 87 in the arrangement direction d₁ of the unit prisms, in other words, the length of each second surface 87 as it is projected in a direction (front direction nd in the illustrated embodiment) perpendicular to the arrangement direction d₁ of the unit prisms (see FIG. 7).

d₂<t_{b}<d₁<P/2 (s1)

d₂<t_{b}<d₁<P/3 (s2)

d₂<t_{b}<d₁<Wb₂ (s3)

When the arrangement pitch P of the unit prims 85 is not less than 10 μm and not more than 35 μm, it is preferred that the following relations (s4) and (s5) both hold. If the relations (s4) and (s5) are both satisfied, it becomes possible to secure an optical sheet 60 which can satisfy the conditions (s1) to (s3) without causing the above-described other problems.

t_{b}+1 [μm]≤d₁ [μm]≤10 [μm] (s4)

0.78 [μm]≤d₂ [μm] (s5)

It has been found in the present inventors' studies that it is prefer that the following conditions be satisfied regarding the surface hardness of the optical sheet 60. When the following conditions (d) to (f) are satisfied, the optical sheet 60, having the prism layer 80 and the mat layer 70, can effectively prevent the formation of defects in the prism surface 80a or the mat surface 70a:

Hp<Hm (d)

HB≤Hm≤2H (e)

B≤Hp≤HB (f)

where Hp is the pencil hardness of the prism surface 80a, measured in accordance with JIS K5600-5-4 (1999) (load 750 g, speed 1 mm/s), and Hm is the pencil hardness of the mat surface 70a, measured in accordance with JIS K5600-5-4 (1999) (load 750 g, speed 1 mm/s).

The above reference pencil hardnesses satisfy the following relation: B<HB<F<H<2H.

The optical sheet 60 is handled, e.g. stored or transported, in a stacked state or in a rolled stated before it is assembled into a final device such as a surface light source device. Thus, the optical sheet 60 is handled while the prism surface 80a is in contact with the mat surface 70a of another optical sheet 60 or with the mat surface 70a of a different portion of the same optical sheet 60. Scratches can be formed on the prism surface 80a or the mat surface 70a during the handling. The scratches may cause defects such as a bright point and a dark point (point defect). It has been confirmed that such defects are noticeable especially in an optical sheet 60 having fine unit prisms 85, applied in a small-sized display device.

To deal with the problem of scratches which can be formed before assembling of the optical sheet 60, it may be considered to insert a protective film between the prism surface 80a and the mat surface 70a that oppose each other. However, the use of the protective film directly increases the production cost of the optical sheet 60. Further, the use of the protective film requires an operation to insert the protective film during packing of the optical sheet 60 and, in addition, requires an operation to dispose of the protective film before using the optical sheet 60.

In this regard, it has been found in the present inventors' studies that if the above conditions (d), (e) and (f) are satisfied, the formation of scratches on the prism surface 80a or the mat surface 70a during handling of the optical sheet 60 before its assembling can be effectively prevented even when the optical sheet 60 is one having fine unit prisms 85 and to be applied in a small-sized display device.

The condition (d), which requires the pencil hardness Hm of the mat surface 70a to be higher than the pencil hardness Hp of the prism surface 80a, is intended to prevent the tops of the unit prisms 85 from scratching the mat surface 70a of the mat layer 70. If the pencil hardness Hm of the mat surface 70a is lower than the pencil hardness Hp of the prism surface 80a, scratches are likely to be formed in the mat surface 70a as compared to the prism surface 80a. In contrast, if the condition (d) is satisfied, the prism surface 80a will be so soft that it deforms when an external force is applied thereto and returns to its original state when released from the external force. Scratching on the mat surface 70a can therefore be prevented.

Though not related to scratching that can occur before assembling of the optical sheet 60, the mat surface 70a is preferably hardly deformable from the viewpoint of maintaining a sufficient light diffusing effect of the mat layer 70 during use of the optical sheet 60 after its assembling and from the viewpoint of avoiding optical contact of the mat surface 70a with an adjacent member. In addition, raised portions of irregularities on the mat surface 70a are formed as point-like protrusions due to the presence of the light diffusing particles 71. Particularly in the optical sheet 60 described here, the large-diameter first light diffusing particles 71 and the small-diameter second light diffusing particles 72 are dispersed in the binder resin 73b, and the first light diffusing particles 71 mainly form discrete raised portions of the mat surface 70a. Therefore, compared to the ridge line of the unit prisms 85, constituting the prism surface 80a stronger stress concentration occurs in those portions of the mat layer 70 where the first light diffusing particles 71 are disposed. The condition (d), which requires the pencil hardness Hm of the mat surface 70a to be higher than the pencil hardness Hp of the prism surface 80a, is preferably satisfied also from the viewpoint of withstanding the concentrated stress.

If the pencil hardness Hp of the prism surface 80a is higher than “HB”, the prism surface 80a can scratch the mat surface 70a when rolling up one optical sheet 60 (sheet material 11) or when stacking a large number of optical sheets 60. Similarly, if the pencil hardness Hm of the mat surface 70a is higher than “2H”, the mat surface 70a can scratch the prism surface 80a when rolling up one optical sheet 60 (sheet material 11) or when stacking a large number of optical sheets 60.

If the pencil hardness Hp of the prism surface 80a is lower than “B”, it will be necessary to provide a protective film when rolling up one optical sheet 60 (sheet material 11) or when stacking a large number of optical sheets 60. Thus, the condition (f) needs to be satisfied from the viewpoint of eliminating the use of a protective film. Similarly, if the pencil hardness Hm of the mat surface 70a is lower than “HB”, it will be necessary to provide a protective film when rolling up one optical sheet 60 (sheet material 11) or when stacking a large number of optical sheets 60.

For the above reasons, it is preferred that the optical sheet 60 satisfy the conditions (d) to (f).

An exemplary method for producing the thus-constructed optical sheet 60 will now be described.

The below-described method for producing an optical sheet includes the step of forming a mat layer 70 on a resin film 66 which is to make a substrate layer 65, and the step of forming a prism layer 80 on the resin film 66. The respective steps will now be described together with an apparatus for use in each step.

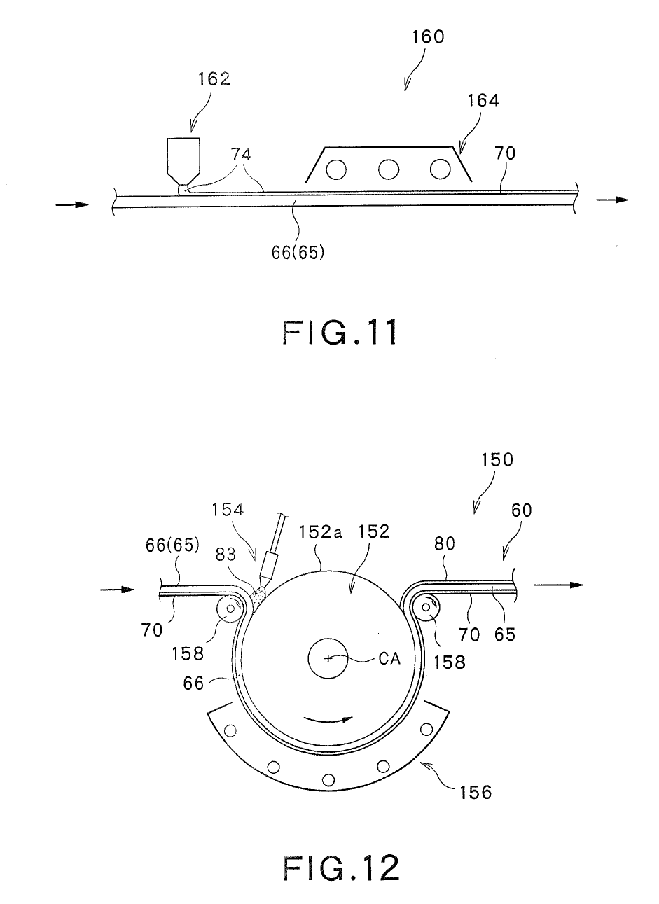

At the outset, the step of forming a mat layer 70 on a resin film 66 will be described with reference to FIG. 11.

A mat layer forming apparatus 160 shown in FIG. 11 is used in this step. The mat layer forming apparatus 160 includes a coating apparatus 162 for applying a resin material 74 containing first light diffusing particles 71 and second light diffusing particles 72 to the resin film 66, and a curing apparatus 164 for curing the resin material 74 on the resin film 66. The coating apparatus 162 shown in 11 is a coater of the type which ejects a liquid resin material from a T-die nozzle. However, it is possible to use various other types of known coaters such as a comma coater, a roll coater, a gravure coater, a bar coater, etc. The curing apparatus 164 may be arbitrarily configured depending on the curing properties of the resin material 74 applied from the coating apparatus 162.

When the resin film 66 extending in a strip shape is supplied to the mat layer forming apparatus 160, the resin material 74 containing the first and second light diffusing particles 71, 72 is applied from the coating apparatus 162 of the mat layer forming apparatus 160 to one surface (upper surface in FIG. 11) of the resin film 66. The resin material 74 then spreads on the resin film 66. The resin film 66, which finally makes the substrate layer 65 of the optical sheet 60, may be e.g. a biaxially oriented polyethylene terephthalate film having a thickness of 30 to 250 μm which has good mechanical properties (strength, etc.), chemical properties (stability, etc.) and optical properties (light transmittance, etc.) and which is available at a low cost.

The resin material 74 supplied from the coating apparatus 162 is to form the binder resin 73 of the mat layer 70. Various known thermosetting or ionizing radiation curable resin materials can be used as the resin material 74. As described above, particles of various known materials, having various known shapes, can be used as the first and second light diffusing particles 71, 72 dispersed in the resin material 74. The following description illustrates a case in which an ionizing radiation curable resin is supplied from the coating apparatus 162. A UV curable resin which is cured by ultraviolet (UV) irradiation or an EB curable resin which is cured by electron beam (EB) irradiation, for example, may be selected as the ionizing radiation curable resin.

The resin film 66, coated with the ionizing radiation curable resin material 74 in which the first and second light diffusing particles 71, 72 are dispersed, passes a position facing the curing apparatus 164 which is emitting ionizing radiation adapted to the curing properties of the ionizing radiation curable resin material 74. Therefore, the ionizing radiation curable resin material 74 on the resin film 66 is irradiated with the ionizing radiation and cured. Consequently, a mat layer 70, composed of the binder resin 74, which is the cured ionizing radiation curable resin 74, and the first and second light diffusing particles 71, 72 dispersed in the ionizing radiation curable resin material 74, is formed on the resin film 66.

The step of forming a prism layer 80 on the opposite side of the resin film 66 from the side on which the mat layer 70 is formed will now be described mainly with reference to FIG. 12. A prism layer forming apparatus 150 shown in FIG. 12 is used in this step.

The prism layer forming apparatus 150 will be described first. As shown in FIG. 12, the prism layer forming apparatus 150 includes a mold 152 having a generally-cylindrical contour. The cylindrical mold 152 has, in its peripheral surface (side surface), a cylindrical mold surface (uneven surface) 152a. The cylindrical mold 152 has a central axis CA passing through the center of the peripheral surface of the cylinder, in other words, passing through the center of the cross-section of the cylinder. Recesses (not shown) corresponding to the unit prims 85 of the optical sheet 60 are formed in the mold surface 152a. Thus, the mold 152 is configured as a roll mold which, while rotating on the central axis CA as the axis of rotation, molds the prism layer 80.

As shown in FIG. 12, the prism layer forming apparatus 150 further includes a material supply apparatus 154 for supplying a resin material 83 having fluidity between the strip-shaped resin film 66 supplied and the mold surface 152a of the mold 152, and a curing apparatus 156 for curing the material 83 between the resin film 66 and the uneven surface 152a of the mold 152. The curing apparatus 156 may be configured appropriately depending on the curing properties of the material 83 to be cured.

A method for producing the prism layer 80 by using the prism layer forming apparatus 150 will now be described. First, the strip-shaped resin film 66 having the mat layer 70 is supplied from mat layer forming apparatus 160 to the prism layer forming apparatus 150. As shown in FIG. 12, the resin film 66 supplied is fed rightward to the mold 152 and held by the mold 152 and a pair of rollers 158 such that it faces the uneven surface 152a of the mold 152. The side of the resin film 66, on which the mat layer 70 is not formed, faces the mold 152.

As shown in FIG. 12, concomitantly with the supply of the resin film 66, a resin material 83 having fluidity is supplied from the material supply apparatus 154 to between the resin film 66 and the mold surface 152a of the mold 152. The material 83 is to make the unit prisms 85 and the land portion 81. The phrase “having fluidity” herein means that the material 83, supplied to the mold surface 152a of the mold 152, has such a degree of fluidity as to allow the material to enter recesses (not shown) in the mold surface 152a.

A variety of materials which are known to be usable for molding can be used as the material 83 to be supplied. The following description illustrates an exemplary case in which an ionizing radiation curable acrylic resin is supplied from the material supply apparatus 154. A UV curable resin to be cured by ultraviolet (UV) irradiation or an EB curable resin to be cured by electron beam (EB) irradiation, for example, may be selected as an ionizing radiation curable resin.

With the ionizing radiation curable resin 83 interposed between the resin film 66 and the mold surface 152a of the mold 152, the resin film 66 passes a position facing the curing apparatus 156 which is emitting ionizing radiation adapted to the curing properties of the ionizing radiation curable resin 83. The ionizing radiation passes through the mat layer 70 and the resin film 66, and is applied to the ionizing radiation curable resin 83. When the ionizing radiation curable resin 83 is a UV curable resin, the curing apparatus 156 may be a UV irradiation apparatus, such as a high-pressure mercury lamp. The curing apparatus 156 cures the ionizing radiation curable resin 83 between the mold surface 152a and the resin film 66 to form a prism layer 80, comprising unit prisms 85 and a land portion 81 and made of the cured ionizing radiation curable resin 83, on the resin film 66.

Thereafter, as shown in FIG. 12, the resin film 66 is detached from the mold 152, whereby the unit prisms 85, formed in the recesses of the mold surface 152a, are detached at the position of a right roller 158 from the mold 152 along with the land portion 81 located between the mold 152 and the resin film 66. This molding method can effectively prevent the molded unit prisms 85 from partly remaining in the recesses of the mold 152 upon detachment of the unit prisms 85 from the mold 152.

While the mold 152, configured as a roll mold, rotates one revolution on the central axis CA, the step of supplying the resin material 83 having fluidity into the mold 152, the step of curing the resin material 83 in the mold 152, and the step of drawing the cured resin material 83 from the mold 152 are carried out sequentially on the mold surface 152a of the mold 152 in the above-described manner to produce the prism layer 80.

An optical sheet 60, consisting of the substrate layer 65 of the resin film 66, the mat layer 70 formed on one side of the substrate layer 65, and the prism layer 80 formed on the other side of the substrate layer 65, is thus produced. It is also possible to use a method in which, unlike the above-described method, the prism layer 80 is first formed on the resin film 66, and then the mat layer 70 is formed on the resin film 66.

The operation of the thus-constructed display device 10 will now be described.

As shown in FIGS. 1 and 2, light emitted by the light emitters 25 of the light source 24 passes through the light entrance surface 33 and enters the light guide plate 30. As shown in FIG. 2, lights L21, L22 that have entered the light guide plate 30 repeat reflection, in particular total reflection at the light exit surface 31 and the back surface 32 due to the difference in refractive index between air and the material of the light guide plate 30, and travels in the first direction (light guide direction) d₁ connecting the light entrance surface 33 and the opposite surface 34 of the light guide plate 30.

The back surface 32 of the light guide plate 30 includes the inclined surfaces 37 which are each inclined such that the distance to the light exit surface 31 decreases with the increasing distance from the light entrance surface 33. Two adjacent inclined surfaces 37 are connected via a stepped surface 38 and a connecting surface 39. The stepped surfaces 38 extend in the normal direction nd of the plate plane of the light guide plate 30. Therefore, most of light, traveling in the light guide plate 30 from the light entrance surface 33 toward the opposite surface 34, reflects at an inclined surface(s) 37 or a connecting surface(s) 39 without entering a stepped surface 38. When light is reflected at an inclined surface 37 in the back surface 32, the reflection increases the inclination angle of the traveling direction of the light with respect to the plate plane of the light guide plate 30 in the cross-section shown in FIG. 2. Thus, when light is reflected at an inclined surface 37 in the back surface 32, the reflection decreases the incident angle of the light later entering the light exit surface 31 or the back surface 32. Accordingly, the incident angle of light entering the light exit surface 31 or the back surface 32 decreases by at least one reflection at an incline surface(s) 37 of the back surface 32, and will become less than the critical angle for total reflection. The light can therefore exit the light exit surface 31 or the back surface 32 of the light guide plate 30. The lights L21, L22 that have exited the light exit surface 31 travel toward the optical sheet 60 disposed on the light exit side of the light guide plate 30. On the other hand, light that has exited the back surface 32 is reflected by the reflective sheet 28 disposed behind the light guide plate 30, and re-enters the light guide plate 30 and travels in it.

Particularly in the illustrated embodiment, the proportion of the area of an inclined surface 37 in the back surface 32 increases as the distance of the inclined surface 37 from the light entrance surface 33 in the light guide direction increases. This makes it possible to ensure a sufficient amount of light, exiting the light exit surface 31 of the light guide plate 30, in a region remote from the light entrance surface 33 where the amount of exiting light tends to be small, thereby making uniform the distribution of the amount of exiting light along the light guide direction.

The light exit surface 31 of the illustrated light guide plate 30 is composed of the unit optical elements 50. The cross-sectional shape of each unit shaped element 50 in the main cross-section is a pentagonal shape which is symmetrical with respect to the front direction, or a generally pentagonal shape in which one or more corners of the pentagonal shape are chamfered. In particular, as described above, the light exit surface 31 of the light guide plate 30 is configured as bent surfaces which are inclined with respect to the back surface 32 of the light guide plate 30 (see FIG. 5). The bent surfaces consist of the pairs of inclined surfaces 35, 36. The inclined surfaces 35, 36 of each pair are inclined symmetrically with respect to the normal direction nd to the light exit-side surface 41 of the base portion 40. Light which totally reflects at the inclined surfaces 35, 36 and travels in the light guide plate 30 and light which passes through the inclined surfaces 35, 36 and exits the light guide plate 30 are subject to the following effects of the inclined surfaces 35, 36. The effects to be exerted on light which totally reflects at the inclined surfaces 35, 36 and travels in the light guide plate 30 will be described first.

FIG. 5 shows, in the main cross-section of the light guide plate 30, the paths of lights L51, L52 which travel in the light guide plate 30 while repeating total reflection at the light exit surface 31 and the back surface 32. As described above, each pair of the inclined surfaces 35, 36, constituting the light exit surface 31 of the light guide plate 30, are inclined symmetrically with respect to the normal direction nd to the light exit-side surface 41 of the base portion 40. The two types of symmetrically inclined surfaces 35, 36 are arranged alternately along the second direction d₂. As shown in FIG. 5, the lights L51, 52, traveling in the light guide plate 30 toward the light exit surface 31 and reaching the light exit surface 31, in most cases reach an inclined surface which is inclined toward the opposite direction to the traveling directions of the lights from the normal direction nd to the light exit-side surface 41 of the base portion 40 in the main cross-section of the light guide plate 30.

Consequently, as shown in FIG. 5, when the lights L51, L52, traveling in the light guide plate 30, totally reflect at the inclined surfaces 35, 36 of the light exit surface 31, the reflection in most cases reduces a light component along the second direction d₂. Further, in some cases, the lights L51, L52 come to travel in a direction inclined oppositely from the front direction nd in the main cross-section. In this manner, the inclined surfaces 35, 36, constituting the light exit surface 31 of the light guide plate 30, restrains light, emitted radially from a light emitting point, from keeping spreading out in the second direction d₂. Thus, light which has been emitted from a light emitter 25 of the light source 24 in a direction highly inclined with respect to the first direction d₁ and entered the light guide plate 30, comes to travel mainly in the first direction d₁ while the light is restrained from traveling in the second direction d₂. This makes it possible to control the distribution of the amount of light, exiting the light exit surface 31 of the light guide plate 30, along the second direction d₂ by the construction of the light source 24 (e.g. the arrangement of the light emitters 25), the output of each light emitter 25, etc.

A description will now be given of an optical effect to be exerted on light passing through the light exit surface 31 and exiting the light guide plate 30. As shown in FIG. 5, lights L51, L52, exiting the light guide plate 30 through the light exit surface 31, are refracted at the light exit-side surfaces of the unit optical elements 50, constituting the light exit surface 31 of the light guide plate 30. Due to the refraction, the lights L51, L52, each traveling in a direction inclined from the front direction nd, are bent such that the angle of the traveling direction (exit direction) of each light with respect to the front direction nd in the main cross-section becomes smaller. Thus, the unit optical elements 50 can reduce a light component along the second direction d₂ perpendicular to the light guide direction and narrow the traveling direction of transmitted light down to the front direction nd. The unit optical elements 50 thus exert a light condensing effect on a light component traveling in the second direction d₂ perpendicular to the light guide direction. In this manner, the exit angle of light exiting the light guide plate 30 is narrowed down to a narrow angular range around the front direction in a plane parallel to the arrangement direction of the unit optical elements 50 of the light guide plate 30.

As described above, the exit angle of light exiting the light guide plate 30 is narrowed down to a narrow angular range around the front direction in a plane parallel to the arrangement direction of the unit optical elements 50 of the light guide plate 30. On the other hand, as shown in FIG. 2, since light travels in the light guide plate 30 mainly in the first direction d₁, light generally exits the light guide plate 30 at a relatively large exit angle θk, i.e. exits the light guide plate 30 in a direction relatively highly inclined from the front direction nd. In particular, the exit angle of the first-direction component of light exiting the light guide plate 30 (the angle θk (see FIG. 2) formed between the first-direction component of exiting light and the normal direction nd to the plate plane of the light guide plate 30) tends to lie in a narrow angular range of relatively large angles. The light guide plate 30 having the above-described shape and dimensions can be designed so that the peak luminance lies e.g. in an angular range of 65° to 80° (particularly 65° to 75°) with respect to the normal direction nd to the plate plane of the light guide plate 30.

Light that has exited the light guide plate 30 enters the optical sheet 60. As described above, the optical sheet 60 has the unit prisms 85 whose tops 88a project toward the light guide plate 30. As well shown in FIG. 2, the longitudinal direction of the unit prisms 85 is parallel to a direction intersecting the light guide direction (the first direction) d₁ in which light is guided in the light guide plate 30, and particularly in this embodiment is parallel to the second direction d₂ perpendicular to the light guide direction.

Accordingly, lights L21, L22, which have been emitted by the light source 24 disposed on one side (left side in FIG. 2) in the first direction d₁, passed through the light guide plate 30, and are traveling toward the optical sheet 60, each enter a unit prism 85 through the first surface 86, of the first and second surfaces 86, 87 connected to each other, located on one side nearer to the light source 24 in the first direction d₁. As shown in FIG. 2, the lights L21, L22 then totally reflect at the second surface 87 located on the other side (right side in FIG. 2) farther from the light source 24 in the first direction d₁, thereby changing the traveling direction.

Due to the total reflection at the second surfaces 87 of unit prisms 85, the lights L21, L22, each traveling in a direction inclined from the front direction nd in the main cross-section of FIG. 2 (cross-section parallel to both the first direction (light guide direction) d₁ and the front direction nd), are bent such that the angle of the traveling direction of each light with respect to the front direction nd becomes smaller. Thus, with reference to a light component along the first direction (light guide direction) d₁, the unit prisms 85 can narrow the traveling direction of the transmitted light down to the front direction nd. The optical sheet 60 thus exerts a light condensing effect on a light component along the first direction d₁.

Light whose traveling direction is thus significantly changed by the unit prisms 85 of the optical sheet 60 is mainly a light component traveling in the first direction d₁, i.e. the arrangement direction of the unit prisms 85, and thus differs from the light component traveling in the second direction which is condensed by the inclined surfaces 35, 36 of the unit optical elements 50 of the light guide plate 30. Accordingly, the front-direction luminance, which has been increased by the unit optical elements 50 of the light guide plate 30, is not impaired and can be further increased by the optical effect of the unit prisms 85 of the optical sheet 60.

Light that has exited the light guide plate 30 and entered the optical sheet 60 is diffused by the mat layer 70 and exits the optical sheet 60. The diffusion of light by the mat layer 70 can obscure or hide defects formed in the optical sheet 60 or the light guide plate 30. For example, if a bright point or a dark point (point defect) is formed e.g. due to a scratch or a dent produced during the production of the optical sheet 60 or the light guide plate 30, the light diffusing effect of the mat layer 70 can make the defect invisible. The light diffusing effect of the mat layer 70 can broaden the allowable range of defects in the reflective sheet 28, the light guide plate 30 or the mat layer 70. This can increase the yield of the reflective sheet 28, the light guide plate 30 or the mat layer 70. Further, the light diffusing effect of the mat layer 70 can smoothen the angular distribution of luminance, measured on the light emitting surface 21 of the light source device 20. This makes it possible to effectively avoid a significant change in the brightness of an image when a viewer changes the angle of viewing the image, and to provide an angular range (viewing angle) that enables appropriate viewing of images. From the viewpoint of imparting an effective hiding effect to the optical sheet 60, the haze value of the whole optical sheet 60, including the mat layer 70 and the prism layer 80, is preferably not less than 90% and not more than 100%, more preferably not less than 95% and not more than 100%. The haze value can be measured in accordance with JIS K7105.

Light that has exited the optical sheet 60 enters the lower polarizing plate 14 of the liquid crystal display panel 15. The lower polarizing plate 14 transmits one polarization component (P wave in this embodiment) of incident light and absorbs the other polarization component (S wave in this embodiment). Light that has passed through the lower polarizing plate 14 selectively passes through the upper polarizing plate 13 depending on the application of an electric field to each pixel. By thus selectively transmitting light from the surface light source device 20 for each pixel by means of the liquid crystal display panel 15, a viewer can view an image on the liquid crystal display device 10.

FIG. 13 shows the angular distribution of luminance, measured on the light emitting surface 21 of the surface light source device 20. The luminance distribution is the results of an actual measurement of luminance made in various directions in a plane parallel to both the first direction d₁ and the front direction nd. The “Experimental Results 1” in FIG. 13 indicates the results of an experiment which was conducted using as the reflective sheet 28 a white PET sheet having a diffusion/reflection function. The “Experimental Results 2” in FIG. 13 indicates the results of an experiment which was conducted using as the reflective sheet 28 a PET sheet with a vapor-deposited silver film having a mirror reflection function (regular reflection function). As shown in FIG. 13, the luminance characteristics at the light emitting surface 21 can be controlled also by changing the reflection characteristics of the reflective sheet 28.

As mentioned in the Background Art section, it has been confirmed that when a surface light source device, including an optical sheet having a mat layer and a prism layer, is used as a backlight, and a display panel having a pixel array is illuminated from the back, there may occur a problem, so-called “glare”, which is the phenomenon of the appearance of a number of granular visible color components. The present inventors' studies have revealed that the problem is prominent when the array of unit prisms, included in the prism layer, is very fine, in particular when the arrangement pitch of the unit prisms is as narrow as 10 μm to 35 μm.

On the other hand, according to the above-described optical sheet 60, the mat layer 70 contains the second light diffusing particles 72 and the binder resin 73, and the following conditions (x) and (y) related to the second light diffusing particles 72 and the binder resin 73 are satisfied:

(x) the refractive index n₂ of the second light diffusing particles 72 of the mat layer 70 differs from the refractive index n_{b} of the binder resin 73, and

(y) the average particle diameter d₂ of the second light diffusing particles 72 and the thickness t_{b} of the mat layer 70 in those regions where no first light diffusing particles 71 and no second light diffusing particles 72 are present, satisfy the following condition (a′): d₂<t_{b} (a′).

The optical sheet 60 which satisfies the conditions (x) and (y) can effectively obscure glare.

Though the reason for the fact that the use of the optical sheet 60 which satisfies the conditions (x) and (y) can effectively obscure glare is not yet fully clear, it is estimated that the following may be one reason. It should be noted, however, that the present invention is not bound by the following estimation.

In a conventional common practice, light diffusing particles having a particle diameter larger than the thickness of a binder resin are used in a layer having an uneven surface, called a mat layer. Such light diffusing particles project like convex lenses in the mat layer.

On the other hand, in the unit prisms of a prism layer located nearer to a light source than the mat layer, the inclined surface (first surface 86) of each unit prism, located near to the light source in the arrangement direction of the unit prisms, functions as a light entrance surface, while the inclined surface (second surface 87) of the unit prism, located farther from the light source in the arrangement direction, functions as a reflective surface. It is estimated that since the light source-side surfaces and the opposite-side surfaces of the unit prisms contained in the prism layer thus perform different roles, a bright/dark pattern at the arrangement pitch of the unit prisms is formed on the light exit side of the prism layer as shown in FIGS. 9 and 10.

Depending on a particular combination of the arrangement pitch of the unit prisms and the particle diameter of the light diffusing particles, due to the lens effect of those portions of the mat layer which project like convex lenses, the bright/dark pattern can be enlarged to the same level as the pitch of a pixel array. In that case, a granular pattern may be formed e.g. due to prevention of transmission of light in particular sub-pixels. Especially in color display, coloration of a particular color component can be prevented. It is estimated that such a phenomenon will appear as “glare”, the phenomenon of the appearance of a number of granular visible color components which differ from colors to be duly displayed.

On the other hand, according to the above condition (y), most of the second light diffusing particles 72 are buried in the binder resin 73. According to the above condition (x), the second light diffusing particles 72, buried in the binder resin 73, change the traveling direction of light at the interfaces between them and the binder resin 73. Thus, the mat layer 70 has an internal diffusing function. Some second light diffusing particles 72 align in the thickness direction of the mat layer 70. Further, due to shrinkage of the binder resin 73 upon its curing, the surface of the mat layer 70 is an uneven surface though the surface irregularities are relatively small. Therefore, compared to the conventional mat layer whose light diffusing effect is mainly produced by diffusion of light at the uneven surface, light diffusions at various positions in the thickness direction are superimposed in the mat layer 70 described here, which produces a remarkably uniformized light diffusing effect. It therefore becomes possible to reduce the bright/dark pattern and to effectively obscure glare which is estimated to be caused by the above-described lens effect, or even avoid the occurrence of glare.

It is possible that if the mat layer 70 only satisfies the conditions (x) and (y), the irregularities of the mat surface 70 a may be too small. Such mat layer 70 can cause defects, such as an interference pattern or a wetting pattern looking like staining with a liquid, when the optical sheet 60 is superimposed on another member. In order to avoid the formation of such defects, the mat layer 70 of the optical sheet 60 described here further contains the first light diffusing particles 71 which are made of a material different from the material of the second light diffusing particles 72 and which satisfy the following condition (z):

(z) the average particle diameter d₁ of the first light diffusing particles 71 and the thickness t_{b} of the mat layer 70 in those regions where no first light diffusing particles 71 and no second light diffusing particles 72 are present, satisfy the following condition (a″): t_{b}<d₁ (a″).

As well shown in FIG. 7, when the condition (z) is satisfied, the mat surface 70a of the mat layer 70 is an uneven surface in which raised portions are formed in those regions where the first light diffusing particles 71, having an average particle diameter d₁ larger than the thickness t_{b} of the mat layer 70, are present. The raised portions can effectively eliminate defects that could be formed when the optical sheet 60 is superimposed on another member.

The effect of making glare invisible and the effect of preventing defects from being formed when the optical sheet 60 is superimposed on another member change depending on the relationship between the average particle diameter d₁ of the first light diffusing particles 71, the average particle diameter d₂ of the second light diffusing particles 72 and the arrangement pitch P of the unit prisms 85 in the first direction d₁. Therefore, such parameters are set so as to maximize both the effect of making glare invisible and the effect of preventing defects upon superimposition of the optical sheet 60 on another member. Thus, by selecting the average particle diameter d₁ of the first light diffusing particles 71 and the average particle diameter d₂ of the second light diffusing particles 72 depending on the arrangement pitch P of the unit prisms 85 in the first direction d₁, it becomes possible to effectively obscure glare which has become a problem with the progress toward finer arrangement pitch P of unit prisms 85. In particular, as described above, it is preferred that the following condition (s1) be satisfied, and it is more preferred that the following condition (s2) be satisfied. It has also been found that glare can be very effectively obscured by setting the parameters so that the following condition (s3) is satisfied.

d₂<t_{b}<d₁<P/2 (s1)

d₂<t_{b}<d₁<P/3 (s2)

d₂<t_{b}<d₁<Wb₂ (s3)

As described above with reference to FIG. 2, in the case where the light source 24 is disposed beside only the one side surface 33 of the light guide plate 30, the traveling directions of lights L21, L22 exiting the light exit surface 31 of the light guide plate 30 are highly inclined from the front direction nd. Consequently, the first surface 86 of each unit prism 85, located on the side nearer to the light source 24 in the arrangement direction d₁ of the unit prisms 85, functions as a light entrance surface, while the second surface 87, located on the side farther from the light source 24 in the arrangement direction d₁, functions as a reflective surface. The second surfaces 87 totally reflect the lights L21, L22, thereby directing the traveling directions of the lights L21, L22 toward approximately the front direction nd. Therefore, areas onto which the second surfaces 87 are projected in the front direction nd are observed as bright areas. On the other hand, the amount of light, exiting areas that face the first surfaces 86 in the front direction nd, is significantly small. Therefore, areas onto which the first surfaces 86 are projected in the front direction nd are observed as dark areas. It is thus estimated that a bright/dark pattern at the arrangement pitch of the unit prims 85 is formed on the light exit side of the prism layer 80 as shown in FIGS. 9 and 10. It is estimated through the present inventors' studies that when one light diffusing particle is disposed such that it entirely covers an area onto which one second surface 87 is projected in the front direction nd, the light diffusing particle has a large lens effect on light, resulting in the occurrence of glare. This estimation is made on the assumption that light from one bright area becomes more visible by the lens effect of one light diffusing particle.

If the above condition (s1) is satisfied, the optical sheet 60 can effectively prevent one first light diffusing particle 71 from being disposed such that it entirely covers an area onto which one second surface 87 is projected in the front direction, in other words, prevent one first light diffusing particle 71 from controlling the paths of all the lights condensed by one second inclined surface. If the above condition (s2) is satisfied, the optical sheet 60 can substantially prevent one first light diffusing particle 71 from being disposed such that it entirely covers an area onto which one second surface 87 is projected in the front direction. If the above condition (s3) is satisfied, the optical sheet 60 can prevent one first light diffusing particle 71 from being disposed such that it entirely covers an area onto which one second surface 87 is projected in the front direction. Accordingly, the optical sheet 60 can quite effectively avoid glare. Thus, the present inventors have found that it is effective for obscuring glare to adjust the average particle diameter d₁ of the first light diffusing particles 71 and the average particle diameter d₂ of the second light diffusing particles 72 depending on the arrangement pitch P of the unit prisms 85.

It has also been found that by setting the parameters so that both of the following relations (s4) and (s5) are satisfied when the arrangement pitch P of the unit prims 85 is such fine as not less than 10 μm and not more than 35 μm, the optical sheet 60 can adequately ensure the quality required for application in the liquid crystal display device 10 while effectively obscuring glare.

t_{b}+1 [μm]≤d₁ [μm]≤10 [μm] (s4)

0.78 [μm]≤d₂ [μm] (s5)

In the embodiments illustrated in FIGS. 9 and 10, the second surfaces 87 which form bright areas are formed as bend surfaces. Each second surface 87 is composed of portions (element surfaces) 87a, 87b, 87c having different reflective surface angles θb. In the case of the prism layer 80 having such unit prisms 85, it is possible that, depending on the light exit characteristics of the light exit surface 31 of the light guide plate 30, one of the portions (element surfaces) 87a, 87b, 87c, constituting a bent surface, may form a brighter area. Thus, it is conceivable that when exiting light from the light exit surface 31 of the light guide plate 30 is directed to a particular direction, light reflected at one of the portions 87a, 87b, 87c may appear relatively bright in the front direction. Further, it is possible that reflected light from one of the portions (element surfaces) 87a, 87b, 87c may appear particularly bright due to the lens effect of a second light diffusing particle(s) 72. To avoid such a problem, it is preferred that the following condition (s6) be satisfied. Wb₂ₚₘᵢₙ in the condition (s6) represents the minimum value of the lengths Wb₂ₚₐ, Wb_{2pb}, Wb_{2pc}, of the portions (element surfaces) 87a, 87b, 87c, each constituting one surface contained in each bent second surface 87, in the arrangement direction d₁ of the unit prisms, in other words, the minimum value of the lengths Wb₂ₚₐ, Wb_{2pb}, Wb_{2pc} of the portions (element surfaces) 87a, 87b, 87c, each constituting one surface contained in each bent second surface 87, as they are projected in a direction (front direction nd in the illustrated embodiment) perpendicular to the arrangement direction d₁ of the unit prisms.

d₂<Wb₂ₚₘᵢₙ (s6)

If the condition (s6) is satisfied, the optical sheet 60 can effectively prevent one second light diffusing particle 72 from being disposed such that it entirely covers an area onto which any element surface, contained in each bent second surface 87, is projected in the front direction. It has been confirmed by the present inventors that if the condition (s6) is satisfied, glare can be avoided quite effectively

As described hereinabove, according to the above embodiments, the mat layer 70 of the optical sheet 60 contains the first light diffusing particles 71, the second light diffusing particles 72 and the binder resin 73. The refractive index n₂ of the second light diffusing particles 72 differs from the refractive index n_{b} of the binder resin 73 and the refractive index n₁ of the first light diffusing particles 71. Further, the average particle diameter d₁ of the first light diffusing particles 71, the average particle diameter d₂ of the second light diffusing particles 72, and the thickness t_{b} of the mat layer 70 in those regions where no first light diffusing particles 71 and no second light diffusing particles 72 are present, satisfy the following relation: d₂<t_{b}<d₁. Such an optical sheet 60 can effectively obscure glare.

Various changes and modifications may be made to the embodiments described above. Some exemplary variations will now be described with reference to the relevant drawings. In the following description and relevant drawings, the same reference numerals are used to indicate the same or equivalent components as used in the above-described embodiments, and a duplicate description thereof is omitted.

While an example of the unit prisms 85 of the optical sheet 60 has been described above, various modifications may be made thereto. For example, the unit prisms 85 contained in the prism layer 80 may have different constructions. Further, each unit prism 85 may have a cross-sectional shape other than that shown in FIG. 7 in the main cross-section, for example, a triangular shape, a pentagonal shape or a hexagonal shape.

While an example of the unit optical elements 50 of the light guide plate 30 has been described above, various modifications may be made thereto. For example, the unit optical elements 50 contained in the light guide plate 30 may have different constructions. Further, each unit optical element 50 may have a cross-sectional shape other than that shown in FIG. 5 in the main cross-section, for example, a triangular shape or a semicircular shape.

In the above-described embodiment the back surface 32 of the light guide plate 30 has the inclined surfaces 37 as a construction to cause light to exit the light guide plate 30. However, instead of or in addition to the inclined surfaces 37, the light guide plate 30 may have another construction (another light extracting construction) as a construction to cause light to exit the light guide plate 30. Such another light extracting construction may be exemplified by a construction which involves dispersing a light diffusing component in the light guide plate 30, a construction which involves configuring at least one of the light exit surface 31 and the back surface 32 as a rough surface, and a construction which involves providing a patterned white scattering layer on the back surface 32.

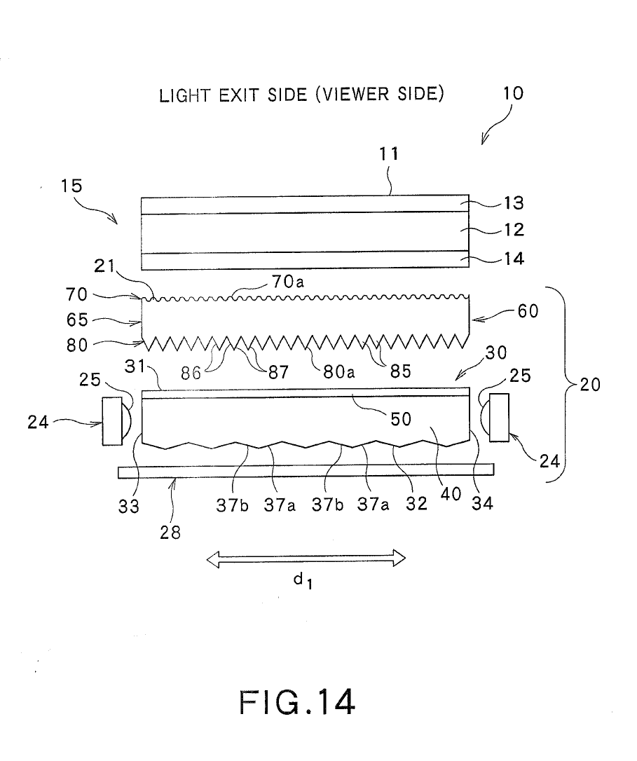

Though in the above-described embodiment only one of the side surfaces of the light guide plate 30 constitutes the light entrance surface 33, the present invention is not limited to this feature. For example, as in the variation shown in FIG. 14, an additional light source 24 may be disposed opposite the opposite surface 34 of the light guide plate 30, and thus the opposite surface 34 may also function as a light entrance surface. In the edge-light type surface light source device shown in FIG. 14, having the light sources 24 disposed beside both of the opposing surfaces 33, 34 of the light guide plate 30, the back surface 32 of the light guide plate 30 is formed by pairs of two types of inclined surfaces 37a, 37b which are inclined symmetrically with respect to the normal direction nd. In this variation each unit prism 85 of the optical sheet 60, in the main cross-section perpendicular to the longitudinal direction, has an isosceles triangular shape having symmetrical prism surfaces. Alternatively, though not shown diagrammatically, each unit prism 85 of the optical sheet 60 may have, in the main cross-section, a pentagonal shape whose opposing bent surfaces each consist of a first surface and a second surface.

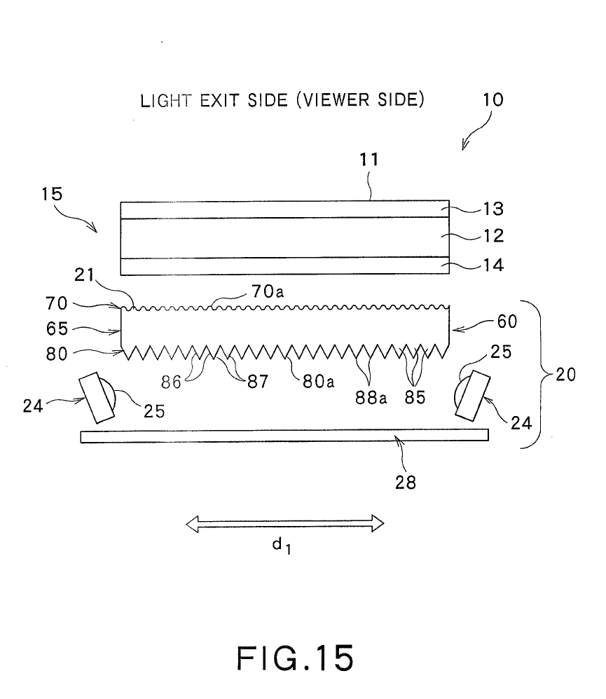

Though in the above-described embodiment light from the light source 24 travels to the optical sheet 60 via the light guide plate 30, the present invention is not limited to this feature. As shown in FIG. 15, light from the light source 24 may directly enter the optical sheet 60.

Though not shown diagrammatically, a known reflective polarizer (also called a polarization separation film) may be disposed between the light exit surface of the optical sheet 60 (the light emitting surface 21 of the surface light source device in FIG. 1) and the lower polarizing plate 14 of the liquid crystal display panel 15 in the surface light source device 20. The reflective polarizer transmits only a particular polarization component of light exiting the optical sheet 60, and does not absorb but reflects a polarization component perpendicular to the particular polarization component. The polarization component reflected from the reflective polarizer is reflected by the mat layer 70, the reflective sheet 28, etc., whereby the polarization component is depolarized (converted into light comprising both the particular polarization component and the polarization component perpendicular to the particular polarization component). The depolarized light re-enters the reflective polarizer. The reflective polarizer transmits the particular polarization component of the depolarized light and reflects again the polarization component perpendicular to the particular polarization component. The above process is repeated, whereby about 70 to 80% of exiting light from the optical sheet 60 becomes the particular polarization component and exits the reflective polarizer. Thus, by making the polarization direction of the particular polarization component (transmission axis component) for the reflective polarizer coincide with the transmission axis direction of the lower polarizing plate 14 of the liquid crystal display panel 15, it becomes possible to use all the exiting light from the surface light source device 20 for the formation of an image on the liquid crystal display panel 15. Therefore, compared to the case of not using a reflective polarizer, an image can be formed with higher brightness even though the same amount of light energy is supplied from the light source 24, and the use efficiency of the energy of the light source 24 (or its power source) can be increased.

The construction of such a surface light source device using a reflective polarizer, per se, is known as disclosed in Published Japanese Translation No. H9-506985 of the PCT International Publication, Japanese Patent No. 3434701, etc. It has been found in the present inventors' studies that when the optical sheet 60 of the present invention is applied in such a surface light source device, the front-direction luminance of polarized light on the light emitting surface 21 of the surface light source device depends on the shape of the unit prisms 85, and that the front-direction luminance of polarized light can be maximized by optimizing the shape of the unit prisms 85.

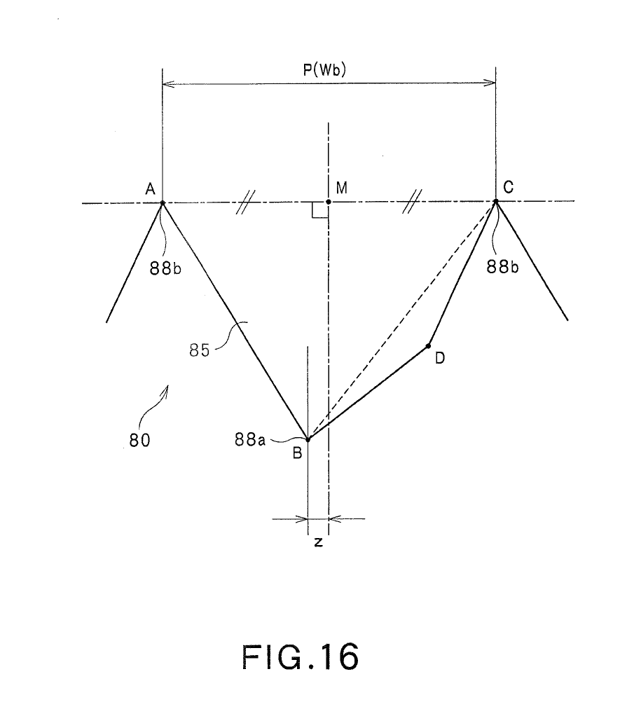

The following description will be made mainly with reference to FIG. 16 (drawing of the below-described sample 1). It has been found that the following three shape factors regarding the shape of the unit prisms 85 in the main cross-section affect the front-direction luminance of polarized light, measured on the light emitting surface 21 of the surface light source device:

(1) The ratio (Hb/Wb) of the height Hb to the width Wb of the bottom side (equal to the pitch P in the embodiments illustrated in FIGS. 7, 16 and 17).

(2) The ratio (z/Wb) of the displacement z of the position of the top 88a from the perpendicular bisector of the bottom side to the width Wb of the bottom side. As shown in FIG. 16, the displacement z is the distance between the top 88a (coinciding with the apex B in the figure) and the perpendicular bisector of the bottom side AC, measured in a direction parallel to the bottom side AC. In the figure, M denotes the midpoint of the bottom side.

(3) The ratio (C_{ABDC}/C_{ABC}) of the entire perimeter C_{ABDC} (see FIG. 16) of the shape ABDC of each prism 85 in the main cross-section to the entire perimeter C_{ABC} of the inscribed triangle ABC, and the ratio (C_{ABDC}/Wb) of the entire perimeter C_{ABDC} of the shape ABDC of each prism 85 to the width Wb of the bottom side.

It has been found that the above three shape factors preferably satisfy the following relations in order to maximize the front-direction luminance of polarized light, measured on the light emitting surface 21 of the surface light source device:

0.7≤Hb/Wb≤0.9

|z/Wb|≤0.06

1.06≤C_{ABDC}/C_{ABC}≤1.21

2.70≤C_{ABDC}/Wb≤3.00

The modifications described above can of course be made in an appropriate combination to the above-described embodiments.

### EXAMPLES

The following examples will further illustrate the present invention in greater detail without limiting its scope.

Optical sheet samples 1 to 4 were produced in the following manner.

### <Sample 1>

The sample 1 was an optical sheet consisting of a substrate layer, a mat layer and a prism layer. The mat layer and the prism layer were produced on the substrate layer by the method described above with reference to FIGS. 11 and 12.

### [Substrate Layer]

A 125 μm thick PET film (A4300, manufactured by Toyobo Co., Ltd.), was used as the substrate layer.

### [Prism Layer]

The prism layer, including unit prisms having a cross-sectional shape as shown in FIG. 17 in the main cross-section, was formed on one surface of the substrate layer using a UV curable resin (RC25-750, DIC Corporation). The arrangement pitch P of the unit prisms (equal to the width Wb of the bottom side in the case of this sample) was 18 μm.

### [Mat Layer]

The mat layer comprised a binder resin, first light diffusing particles and second light diffusing particles. The mat layer was produced by using the following composition. The average diameters of the first and second light diffusing particles ware determined by using a precision particle size distribution measuring device “Coulter Multisizer”. The thickness t_{b} of the mat layer in those regions where no first light diffusing particles and no second light diffusing particles are present was 3 μm.

### (Composition)

First and second light diffusing particles/light transmissive resin (mass ratio): 7/100
First light diffusing particles/second light diffusing particles mass ratio): 1.5/8.5
Light transmissive resin: pentaerythritol triacrylate (refractive index 1.51)
First light diffusing particles: acrylic resin, average particle diameter 5 μm (refractive index 1.49)
Second light diffusing particles: styrene resin, average particle diameter 2 μm (refractive index 1.59)

### <Sample 2>

As with the sample 1, the sample 2 was an optical sheet consisting of a substrate layer, a mat layer and a prism layer. As with the sample 1, the mat layer and the prism layer were produced on the substrate layer by the method described above with reference to FIGS. 11 and 12.

### [Substrate Layer]

As with the sample 1, a 125 μm thick PET film (A4300, manufactured by Toyobo Co., Ltd), was used as the substrate layer.

### [Prism Layer]

The prism layer was produced in the same manner as that used for the sample 1.

### [Mat Layer]

The mat layer comprised a binder resin and second light diffusing particles, and did not contain first light diffusing particles. The mat layer was produced by using the following composition. The average diameter of the light diffusing particles was determined by using a precision particle size distribution measuring device “Coulter Multisizer”. The thickness t_{b} of the mat layer in those regions where no light diffusing particles are present was 3 μm.

### (Composition)

Second light diffusing particles/light transmissive resin (mass ratio): 7/100
Light transmissive resin: pentaerythritol triacrylate (refractive index 1.51)
Second light diffusing particles: styrene resin, average particle diameter 2 μm (refractive index 1.59)

### <Sample 3>

As with the sample 1, the sample 3 was an optical sheet consisting of a substrate layer, a mat layer and a prism layer. As with the sample 1, the mat layer and the prism layer were produced on the substrate layer by the method described above with reference to FIGS. 11 and 12.

### [Substrate Layer]

As with the sample 1, a 125 μm thick PET film (A4300, manufactured by Toyobo Co., Ltd), was used as the substrate layer.

### [Prism Layer]

The prism layer was produced in the same manner as that used for the sample 1.

### [Mat Layer]

The mat layer comprised a binder resin and first light diffusing particles, and did not contain second light diffusing particles. The mat layer was produced by using the following composition. The average diameter of the light diffusing particles was determined by a laser-diffraction particle size distribution measuring method. The thickness t_{b} of the mat layer in those regions where no light diffusing particles are present was 3 μm.

### (Composition)

First light diffusing particles/light transmissive resin (mass ratio): 10/100
Light transmissive resin: pentaerythritol triacrylate (refractive index 1.51)
First light diffusing particles: acrylic resin, average particle diameter 5 pm (refractive index 1.49)

### <Sample 4>

The sample 4 was an optical sheet consisting of a substrate layer and a prism layer. The optical sheet of sample 4 did not include a mat layer. As with the sample 1, the prism layer was produced on the substrate layer by the method described above with reference to FIG. 12.

### [Substrate Layer]

As with the sample 1, a 125 μm thick PET film (A4300, manufactured by Toyobo Co., Ltd), was used as the substrate layer.

### [Prism Layer]

The prism layer was produced in the same manner as that used for the sample 1.

### <Evaluation>

Display devices having the construction shown in FIG. 1 were produced by using the optical sheets of samples 1 to 4. The display devices were examined to determine the occurrence of glare, the presence/absence of defects, such as a pattern, caused by superimposition of the optical sheet on the display panel, and the degree of hiding effect. The components, other than the optical sheet, of each display device were those incorporated in a commercially available display device. The evaluation results are shown in Table 1 below. With reference to “glare” in Table 1, “O” indicates that no glare was observed in the sample, while “X” indicates that glare was observed in the sample. With reference to “sticking” in Table 1, “O” indicates that defects, such as a pattern, due to superimposition of the optical sheet on the display panel were not formed in the sample, while “X” indicates that defects, such as a pattern, due to superimposition of the optical sheet on the display panel were formed in the sample. With reference to “hiding effect” in Table 1, “O” indicates that a bright point or a dark point (point defect) was not observed in the sample, while “X” indicates that a bright point or a dark point was observed in the sample.

TABLE 1
Results of evaluation of the samples

| | | Sample 1 | Sample 2 | Sample 3 | Sample 4 |
|---|---|---|---|---|---|
| Construction | Mat layer | present | present | present | absent |
| | First | present | absent | present | absent |
| | diffusing | | | | |
| | particles | | | | |
| | Second | present | present | absent | absent |
| | diffusing | | | | |
| | particles | | | | |
| Evaluation | Glare | ◯ | ◯ | X | X |
| | Sticking | ◯ | X | ◯ | X |
| | Hiding | ◯ | ◯ | ◯ | X |
| | effect | | | | |

1. An optical sheet having a pair of opposing surfaces, comprising:
a sheet-like substrate layer;
a mat layer, formed on one side of the substrate layer, including first light diffusing particles, second light diffusing particles and a binder resin; and
a prism layer, formed on the other side of the substrate layer, including unit prisms arranged in one direction, each unit prism extending linearly in a direction intersecting the one direction,
wherein one of the pair of surfaces is formed as a mat surface of the mat layer, and the other of the pair of surfaces is formed as a prism surface of the prism layer,
wherein a refractive index of the second light diffusing particles differs from a refractive index of the binder resin and a refractive index of the first light diffusing particles, and
wherein the following relation is satisfied:
d₂<t_{b}<d₁
where d₁ is an average particle diameter of the first light diffusing particles, d₂ is an average particle diameter of the second light diffusing particles, and t_{b} is a thickness of the mat layer in those regions where no first light diffusing particles and no second light diffusing particles are present.

2. The optical sheet according to claim 1,
wherein the following relation is satisfied:
d₂ [μm]<t_{b} [μm]<d₁ [μm]<P/2 [μm]
where d₁ is the average particle diameter of the first light diffusing particles, d₂ is the average particle diameter of the second light diffusing particles, t_{b} is the thickness of the mat layer in those regions where no first light diffusing particles and no second light diffusing particles are present, and P is an arrangement pitch of the unit prims in said one direction.

3. The optical sheet according to claim 1,
wherein each unit prism has a first surface which faces one side in said one direction, and a second surface which faces the other side in said one direction, and
wherein the following relation is satisfied:
d₂ [μm]<t_{b} [μm]<d₁ [μm]<Wb₂ [μm]
where d₁ is the average particle diameter of the first light diffusing particles, d₂ is the average particle diameter of the second light diffusing particles, t_{b} is the thickness of the mat layer in those regions where no first light diffusing particles and no second light diffusing particles are present, and Wb₂ is a length of the second surface in said one direction.

4. The optical sheet according to claim 1,
wherein each unit prism has a first surface which faces one side in said one direction, and a second surface which faces the other side in said one direction,
wherein the second surface includes element surfaces disposed such that in a main cross-section of the optical sheet, parallel to both said one direction and a normal direction to the substrate layer, an inclination angle of the second surface with respect to said one direction increases with distance from the top of the unit prism, located farthest from the substrate layer, and takes a maximum value at either base end portion of the unit prism, located closest to the substrate layer, and
wherein the following relation is satisfied:
d₂ [μm]<Wb₂ₚₘᵢₙ [μm]
where d₂ is the average particle diameter of the second light diffusing particles, and Wb₂ₚₘᵢₙ is a minimum value of the lengths of the element surfaces, contained in each unit prism, in said one direction.

5. The optical sheet according to claim 1, wherein the following relation is satisfied:
n₁≤n_{b}<n₂
where n₁ is a refractive index of the first light diffusing particles, n₂ is a refractive index of the second light diffusing particles, and n_{b} is a refractive index of the binder resin.

6. The optical sheet according to claim 1, wherein the following relation is satisfied:
50≤(N₂/N₁)≤200
where N₁ is a number of the first light diffusing particles contained in the mat layer, and N₂ is a number of the second light diffusing particles contained in the mat layer.

7. The optical sheet according to claim 1, having a haze value of not less than 90%.

8. The optical sheet according to claim 1, which is to be superimposed on a display panel, with the mat layer being located on the display panel side of the substrate layer.

9. A surface light source device comprising:
a light guide plate;
a light source disposed lateral to the light guide plate; and
the optical sheet according to claim 1, disposed such that the prism layer faces the light guide plate.

10. A display device comprising:
the surface light source device according to claim 9; and
a display panel disposed opposite the surface light source device.
